(19) United States
(12) Patent Application Publication
(10) Pub. No.: US 2005/0021539 A1
(43) Pub. Date: Jan. 27, 2005

(54) Methods and systems for digital rights management of protected content

(75) Inventors: Kevin M. Short, Durham, NH (US); Peter Dorward, Harvard, MA (US); Ricardo Garcia, Somerville, MA (US); Barry F. Hunt, Andover, MA (US); Michael A. Glover, Durham, NH (US); John Curley, Gorham, ME (US); Jeff Struven, Struven, NH (US); Michael Gallagher, Arlington, MA (US)

Correspondence Address: ROPES & GRAY LLP, ONE INTERNATIONAL PLACE, BOSTON, MA, 02110-2624, US

(73) Assignee: Chaticom, Inc., Hampton Falls, NH (US)

(21) Appl. No.: 10/794,571

(22) Filed: Mar. 5, 2004

Related U.S. Application Data
(60) Provisional application No. 60/452,731, filed on Mar. 7, 2003.

(51) Int. Cl. G06F 7/00

(52) U.S. Cl. 707/100

(57) ABSTRACT

The invention is directed, in one embodiment, to systems and methods relating to managing rights associated with digital content.

### CROSS REFERENCE TO RELATED APPLICATIONS

This application claims the benefit of U.S. Prov. Pat. App. No. 60/452,731, filed on Mar. 7, 2003, and entitled “Method and Apparatus for Digital Rights Management and Watermarking of Protected Content Using Chaotic Systems and Digital Encoding and Encryption”, the entire contents of which are incorporated herein by reference.

### FIELD OF THE INVENTION

The invention, in one embodiment, is generally directed to providing methods and systems for managing the rights to digital content.

### BACKGROUND OF THE INVENTION

There is a growing trend to deliver content in digital form. Today, more and more digital content is being delivered online over private and public networks, such as intranets, the Internet, cable television networks and telephone networks. For a user, digital form allows more sophisticated content, while online delivery improves timeliness and convenience. For a publisher, digital content also reduces delivery costs.

Unfortunately, these worthwhile attributes are often outweighed by the disadvantage that online delivery of information makes it relatively easy to obtain pristine digital content and to pirate the content at the expense, and harm to, the copyright holder. Piracy of digital content is becoming a significant problem, particularly as higher-value content is becoming available. Books and audio recordings are easily available now, and as bandwidths increase, delivery of digital video content becomes more prevalent. With the increase in value of online digital content, the attractiveness of organized and casual theft increases.

Accordingly, there is a need for an improved mechanism for enabling a provider to deliver content securely to a user at a client device, and for managing the digital rights to the content so that the content provider can continue to effectively restrict the use of the content subsequent to transferring the content to the user.

### SUMMARY OF THE INVENTION

The systems and methods of the invention address the deficiencies in the prior art by, in one embodiment, providing a digital rights management (DRM) approach that enables a content provider to regulate the distribution of digital content and to regulate the use of the digital content subsequent to distribution. Preferably, the digital content can be any type of digital content, including, without limitation, audio, image, video, tactile, multimedia, text and/or software content.

According to one aspect, the invention is directed to a method and system for providing digital content from a content source to a first client device. In this aspect, the invention includes: transforming original digital content from the content source into a first transformed digital content representative of a first portion of, but distinct from, the original digital content; creating a first table of characteristics associated with the first transformed digital content; and transmitting the first transformed digital content and a representation of the first table of characteristics to the first client device. According to this aspect of the invention, the first table of characteristics is necessary for inverse transforming the first transformed digital content back into the first portion of the original digital content.

According to one embodiment, the invention includes encrypting the first table of characteristics using an identifier uniquely associated with the first client device to generate the representation of the table transmitted to the first client device. In one implementation, the transformation process includes compressing the original digital content so that the transformed content is smaller than the original digital content by a factor of at least about 10. In other implementations, the transformed content is compressed to be smaller than the original digital content by a factor of at least about 100, 1000, 10,000, or 100,000.

According to another embodiment, the invention employs the first table of characteristics to further compress the first transformed digital content. According to various implementations, the first table of characteristics is smaller than the first transformed digital content by a factor of at least about 100, 1000, 10,000 or 100,000.

In various embodiments, the invention uses the unique identifier either as a digital key or to generate a digital key for encrypting the first table of characteristics. The unique identifier can be, for example, a telephone number, EIN, MIN, MSISDN, serial number, number associated with a SIM card of the first client device, a public/private key encryption process, a MAC address of a modem associated with a computer, a personal identifier uniquely associated with a user, a proprietary identifier, or the like. Additionally, the unique identifier may be any number stored at the first client device. According to one feature, the unique identifier is retrieved from a database of unique identifiers.

According to another feature, the invention optimizes the first table of characteristics for the original digital content and/or the first transformed digital content. The invention may also employ the first table of characteristics to remove redundancy in the first transformed digital content. Preferably, the first table of characteristics includes a dynamically created custom coding table, such as a custom Huffman coding table or an arithmetic coding table.

According to the invention, the first client device, and the second client device discussed below, may be any device capable of receiving digital content. By way of example, the client device may be a wireless telephone, media player, server computer, desktop computer, laptop computer, handheld computer, personal digital assistant, set top box for a television, storage media, a tactile interface device capable of generating a haptic sensation, or the like.

The invention may employ any suitable transformation process. However, preferably, the invention uses a chaotic system to transform the original digital content. According to one embodiment, using a chaotic system for the transformation includes: causing the chaotic system to assume a periodic orbit; generating a periodic waveform for the periodic orbit; weighting the periodic waveform to approximate at least a portion of the original digital content; and merging at least one initialization code and a representation of the weighting to compress the original digital content. The transformation process may also include stabilizing the periodic orbit.

In one aspect, the invention is particularly adapted for use with image and/or video digital content. According to one implementation of this aspect, the invention includes: identifying a trend in the original digital content, and removing the trend from the original digital content. Identifying the trend may include determining a mathematical model for the trend. According to one feature, the invention merges a representation of the trend, the initialization code(s), and the representation of the weighting, to compress the original image and/or video digital content.

Subsequent to the transformed digital content and the representation of the table of contents arriving at the first client device, the first client device decrypts the first table of characteristics using the unique identifier at the first client device, and inverse transforms the first transformed digital content using the decrypted representation of the first table of characteristics to reconstruct the first portion of the original digital content. According to one feature, the invention enables the first client device to play the first portion of the original digital content during its reconstruction at the first client device, but not persistently storing a subset of the reconstructed digital content at the first client device.

According to another embodiment, the invention enables a content provider to regulate the sharing of a portion of the original digital content between the first client device and a second client device. In one practice, the methods of the invention include transmitting the first transformed digital content and the representation of the first table of characteristics from the first client device to the second client device. More particularly, according to one feature, the invention can detect when the portion of the original digital content has been transferred to a second client device that lacks a unique identifier authorizing the second client device to use the portion of the content.

In response to detecting that the second client device is not associated with the unique identifier being employed, in one implementation, the invention aborts the inverse transformation of the digital content. According to another implementation, the invention aborts inverse transformation of the digital content in response to detecting that the first table of characteristics is invalid for the second client device and/or in response to detecting that the unique identifier is not associated with the second client device. According to a further implementation, the invention generates invalid digital content at the second client device in response to detecting that the first table of characteristics is invalid for the second client device and/or in response to detecting that the unique identifier is not associated with the second client device.

According to one embodiment, in response to determining that the second client device is incapable of inverse transforming digital content from the first client device to produce a valid version of the first portion of the original digital content, the invention sends a request for access to the original digital content from the second client device to a host server, which may be a media server or other DRM server, associated with the content provider, and, in response to the host server determining that the second client device is authorized to receive the original digital content, the server transmits a corrected first table of characteristics to the second client device to enable the second client device to inverse transform the digital content into a valid version of the first portion of the original digital content.

According to a related embodiment, in response to determining that the second client device is incapable of inverse transforming the digital content from the first client device, the invention: prompts a user at the second client device to request, from the host server, access to the first portion of the original digital content; generates a billing event at the host server to charge the user of the second client device for access to the first portion of the original digital content; and transmits a corrected first table of characteristics to the second client device to enable the second client device to inverse transform the first transformed digital content into a valid version of the first portion of the original digital content.

According to another aspect, the invention transforms the original digital content into a second transformed digital content representative of a second portion, distinct from the first portion, of the original digital content; creates a second table of characteristics associated with the second transformed digital content, the second table of characteristics being necessary for inverse transforming the second transformed digital content into the second portion of the original digital content; and transmits the second transformed digital content and a representation of the second table of characteristics to the first client device. In a particular implementation of this aspect, the invention encrypts the second table of characteristics, using a unique identifier to generate the representation of the second table of characteristics to be transmitted to the first client device. According to a particular feature of this aspect, the invention employs a chaotic system for encryption.

In one embodiment, the invention provides for streaming a subset of the first transformed digital content to the first client device, and causing a portion of the streamed subset of the first transformed digital content to not be persistently stored at the first client device. The non-persistence of the streamed data may be implemented either by storing the streamed content in volatile memory or, if storing in persistent memory, overwriting the streamed content at a pace rapid enough to effectively cause the stored streamed data to be volatile.

In one particular practice, the second transformed digital content is associated with a portion of the streamed first transformed digital content that is not persistently stored at the first client device, whereas the second transformed digital content is persistently stored at the first client device. In one embodiment, persistent storing of data refers to placing the data in persistent memory, wherein the data is substantially safe from being overwritten for a sufficient length of time.

In one implementation of this aspect, the unique identifier is associated with the first client device. In one aspect, the first client device can decrypt the encrypted second table of characteristics, inverse transform the first and second transformed digital contents, and play a combination of the first portion and the second portion of the original digital content. However, in another implementation, the first transformed digital content includes an associated preview version. According to various features, the preview version is configured to be inferior to the original digital content. By way of example, the preview version may have an inferior quality relative to the original digital content. Alternatively or additionally, the preview version may have a shorter duration than the original digital content.

According to one embodiment of the preview feature, the unique identifier provided to the first client device is not associated with that device, and the first client device can only inverse transform the first transformed digital content and play only the first portion of the original digital content. Preferably, the first portion of the original digital content is associated with a freely-distributable portion of the original digital content intended for playing by any suitable client device, and the second portion of the original digital content is associated with a secure portion of the original digital content requiring decryption of the second table of characteristics. By way of example, the first portion of the original digital content may include an advertisement or promotion, a preview version of the original digital content, or the like.

As mentioned above, in some aspects, the invention enables a content provider to regulate the usage rights granted to a user. By way of example, without limitation, the invention can limit a number of times that the first client device may use the original digital content, restrict the length of time for which the first client device can use the content, and/or restrict the quality of the original digital content usable by the first client device.

In one embodiment, the invention provides varying quality of service levels by partitioning the original digital content into a respective plurality of layers associated with quality of service. In one aspect, the first transformed digital content includes a subset of the layers associated with a desired quality of service level. According to a particular feature of this aspect, the invention provides for varying the quality of service level based, at least in part, on availability of transmission bandwidth; the bandwidth depends on, among other factors, a combination of a data network's load, congestion, traffic, etc.

According to one embodiment, the invention restricts the quality of the content usable by the first client device by manipulating noise-like data contained in the original digital content. By way of example, in one implementation, the invention alters the noise-like data from the original digital content, and in response to determining that the first client device is authorized to use the original digital content, reincorporates suitable data into the original digital content at the first client device to enable substantially accurate reconstruction of the original digital content at the first client device. The suitable data may be produced, at least in part, by using a first noise generator at the first client device, and may include random noise, pseudo-random noise, or a combination of both.

According to a further aspect, the invention provides for digital watermarking of content. By way of example, the invention may uniquely associate the suitable data with the first client device. The invention may accomplish this by associating the first noise generator with the first client device and/or by initializing the first noise generator to an initial state uniquely associated with the first client device. In this way, a unique identifying watermark can be imbedded in the content delivered to the first client device.

According to a related embodiment, in response to determining that the first client device is not entitled to the original digital content, it incorporates unsuitable data into the original digital content at the first client device to degrade reconstruction of the original digital content at the first client device.

As described below in detail, although chaotic encryption is preferably employed with the above described embodiments, any suitable encryption mechanisms may be employed.

### BRIEF DESCRIPTION OF THE DRAWINGS

The foregoing and other objects and advantages of the invention will be appreciated more fully from the following further description thereof, with reference to the accompanying drawings.

FIG. 1A depicts a flowchart of a process for data compression, encryption and transmission according to an illustrative embodiment of the invention.

FIG. 1B depicts a flowchart of a process for reception, decryption and decompression of data according to an illustrative embodiment of the invention.

FIG. 2A depicts a flowchart of a process for retransmission of encrypted data according to an illustrative embodiment of the invention.

FIGS. 2B-2C are flowcharts of a process for reception of retransmitted encrypted data according to an illustrative embodiment of the invention.

FIG. 3 is a plot of a double scroll oscillator resulting from particular differential equations and parameters.

FIG. 4 is a plot of the periodic orbit of the double scroll oscillator of FIG. 3 resulting from a 5-bit initialization code (01011).

FIG. 5 is a plot of the Poincare Map for the double scroll oscillator of FIG. 1.

FIG. 6 is a plot of the symbolic dynamics function r(x) for twelve loops around the double scroll oscillator of FIG. 3.

FIG. 7 is a flow chart of a method for compressing digital content using chaotic systems according to an illustrative embodiment of the invention.

FIG. 8 is a more detailed flow chart of the method of FIG. 7.

FIG. 9 is a conceptual block diagram for a system for compressing digital data using chaotic systems according to an illustrative embodiment of the invention.

FIG. 10 is a more detailed block diagram of the system of FIG. 9.

FIG. 11 is a block diagram of a client digital key generation system according to an illustrative embodiment of the invention.

FIG. 12 is a flow chart depicting a client generation process of the type employed by digital key generation system of FIG. 11.

FIG. 13 is a block diagram of a system particularly adapted for compressing and decompressing audio content using chaotic systems according to an illustrative embodiment of the invention.

FIG. 14 is a flow chart depicting steps for compressing audio content using chaotic systems according to an illustrative embodiment of the invention.

FIG. 15 is a flow chart depicting in greater detail a process for creating a library of basic waveforms for use in compressing audio data, according to an illustrative embodiment of the invention.

FIG. 16 is a plot of a section of a music waveform.

FIG. 17 is a plot of the peak values in harmonic grouping for the music waveform of FIG. 16.

FIG. 18 is a plot of the full periods of three basic waveforms employed in an illustrative embodiment of the invention.

FIG. 19 is a plot of the full periods of the basic waveforms of FIG. 18 after phase and frequency adjustment, according to an illustrative embodiment of the invention.

FIG. 20 is another plot of the section of the music waveform of FIG. 16, redrawn for comparison purposes.

FIG. 21 is a plot of a first approximation of the waveform section of FIG. 20 according to an illustrative embodiment of the invention.

FIG. 22 is a block diagram of a system particularly adapted for compressing and decompressing image content using chaotic systems according to an illustrative embodiment of the invention.

FIG. 23 is a flow chart depicting steps for compressing image content according to an illustrative embodiment of the invention.

FIG. 24 is a grayscale representation of image content.

FIG. 25 is a plot of data for a single slice of a grayscale image representation according to an illustrative embodiment of the invention.

FIG. 26 is a plot of the slice shown in FIG. 25 after detrending according to an illustrative embodiment of the invention.

FIG. 27 is a plot of a first approximation decompressed version of the slice shown in FIG. 25 compressed using chaotic waveforms according to an illustrative embodiment of the invention.

FIG. 28 is a plot of the decompressed version of the grayscale image shown in FIG. 24 compressed using chaotic waveforms according to an illustrative embodiment of the invention.

### DESCRIPTION OF ILLUSTRATIVE EMBODIMENTS

The invention, in one illustrative embodiment, provides methods and systems for digital rights management (DRM) of digital content (e.g., audio data, music data, image data, video data, tactile data, text data, software, other digital data, or a combination thereof) distributed over a network, such as an intranet or the Internet, in either a wired or wireless fashion. According to one feature, the invention incorporates the DRM protection in an intrinsic way to provide secure and managed delivery of the digital content, and to prevent unauthorized usage of the digital content subsequent to such delivery.

According to one illustrative embodiment, the methods and systems of the invention represent the content in a digital format that includes a compressed content and custom tables of characteristics for the compressed and/or original digital content. The tables of characteristics are employed, for example, to remove redundancy and compress, or further compress, the digital content into a more highly-compressed format. According to one practice, the transforming of the original digital content includes compression of the original digital content. In various particular aspects, the transformed digital content produced by the compression is smaller than the original digital content by a factor of at least about 10, 100, 1,000, 10,000, or even 100,000.

In one embodiment, the table of characteristics is employed to further compress the transformed digital content to produce a more highly-compressed content. According to alternative aspects, the table of characteristics is smaller than the transformed digital content by a factor of at least about 100, about 1,000, about 10,000, or about 100,000.

In one embodiment, the systems and methods according to the invention retrieve a unique identifier—for example, associated with a particular client device—from a database or other location, and uses the unique identifier to generate an encryption key. The encryption key is then employed to encrypt the custom tables of characteristics. The invention then transmits the more highly-compressed digital content, along with the encrypted custom tables of characteristics, to a client device, where the unique identifier is also available. At the client device, the invention decrypts the custom tables of characteristics using the unique identifier- to regenerate the correct key. Once the table is decrypted, the table can be applied to expand the more highly-compressed digital content into the original compressed format.

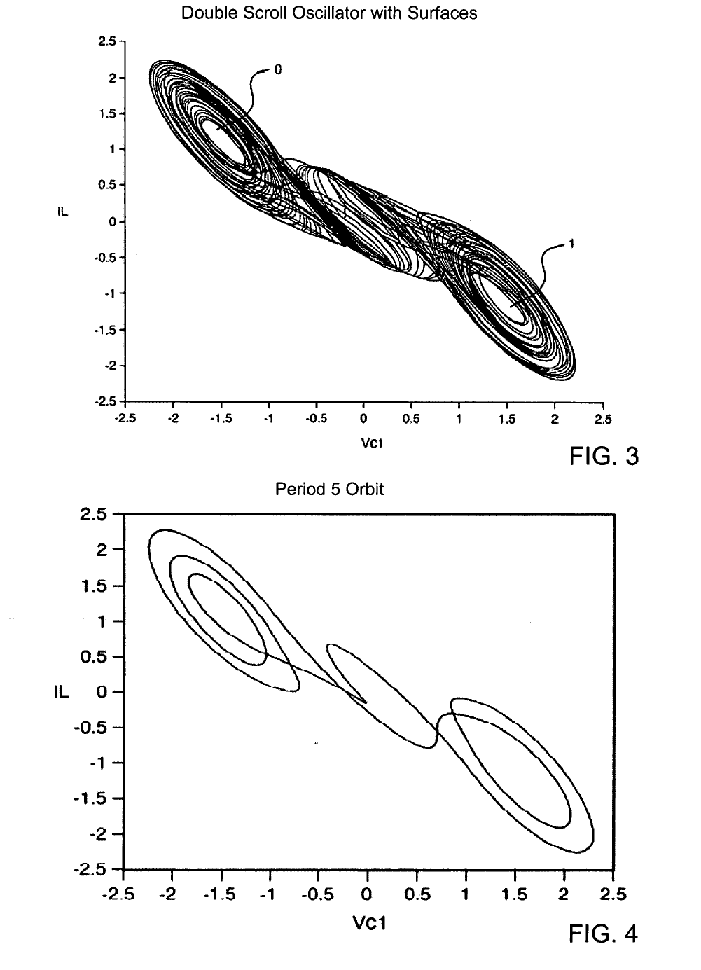

According to one illustrative embodiment, the content distribution and DRM approaches of the invention employ chaotic systems for encryption, decryption, compression and/or decompression of the content being transferred and managed. Use of such chaotic systems is described below in detail, beginning at FIG. 3. However, the DRM and content distribution features of the invention do not necessarily require the use of chaotic systems. Accordingly, the DRM and content distribution features are described first.

In some embodiments of the systems and methods described herein, the DRM features are implemented using a three-level security model, such as that described in detail below beginning at FIG. 3. However, the systems and methods described herein are not limited to supporting such a three-level security model, and it is only for illustrative purposes that the DRM technology is described below with such a model.

In the illustrative three-level security model, the first level of security is provided by transforming the original content into a representation that is distinct from the original content. For example, in one practice, the original content may include raw sampled data from a digital recording. The sampled data is transformed in the encoding process, such that the original content can be reconstructed only by applying an inverse transformation process to the transformed content. The transformation process produces a table of characteristics from the transformed content. The table of characteristics is small, relative to the size of the transformed content and both the table and the transformed content are employed for the inverse transformation process.

Protecting the transformation process, therefore, serves to prevent an unauthorized user from reconstructing the original content from the transformed content and the table of characteristics. That is, a first level of security is provided, whereby an unauthorized user who may intercept the transmission cannot reconstruct the original content from the transformed content and the table of characteristics, for knowledge of how the table of characteristics was produced (i.e., knowledge of the transformation process, and hence the associated inverse transformation process) is necessary to reconstruct the original content from the transmitted data.

The second level of protection is provided by giving only authenticated users access to the content server (host server), and by coupling access to the content server to a billing system, so a billing record is generated when content is accessed at the server. For example, in one practice, each client device is authenticated, and one or more records are generated and/or updated to keep track of downloading and streaming of content. Thus, only registered users operating an authenticated client device may access the content on the server.

The third level of security uses the table of characteristics to lock the content to the client device. In one practice, this process employs a unique identifier residing at the client device, and stored on the server upon service activation, along with an identifier generated in response to each new transaction, to produce a unique key for encrypting the table of characteristics. Once the table of characteristics is encrypted, it can be unlocked only by the authenticated client device. Without unlocking the table of characteristics, the inverse transformation process cannot be completed to reproduce the original content. Thus, the content is locked to the unique client device for which it was intended. This property satisfies the “forward-locking” goal of DRM, since if the data were forwarded to a second client device, the second client device would not be able to interpret the table of characteristics to recreate the content.

The encoding format described above provides great flexibility in the design of distribution solutions for a plurality of applications. According to the illustrative embodiment, the original content is transformed into a .koz compression format. As described in detail below, beginning at FIG. 3, one of the features of the .koz format is that the content is encoded in layers, so that the most significant layers contain salient features, including structures, of the content, but still at a fairly coarse scale. The remaining layers add important features and structures that support a high-quality reproduction of the original content.

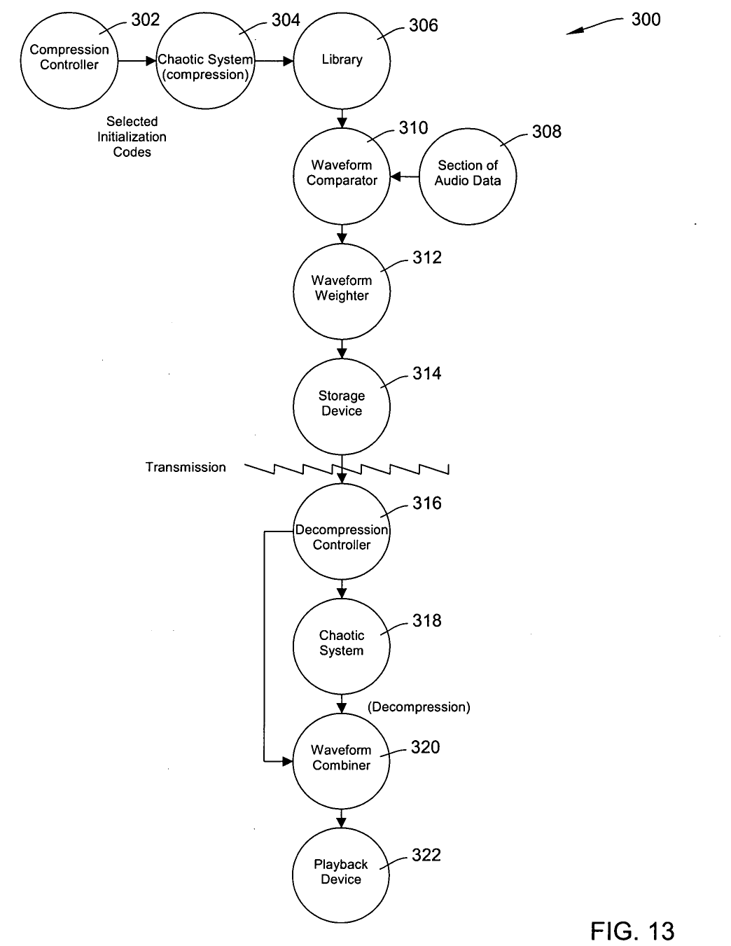

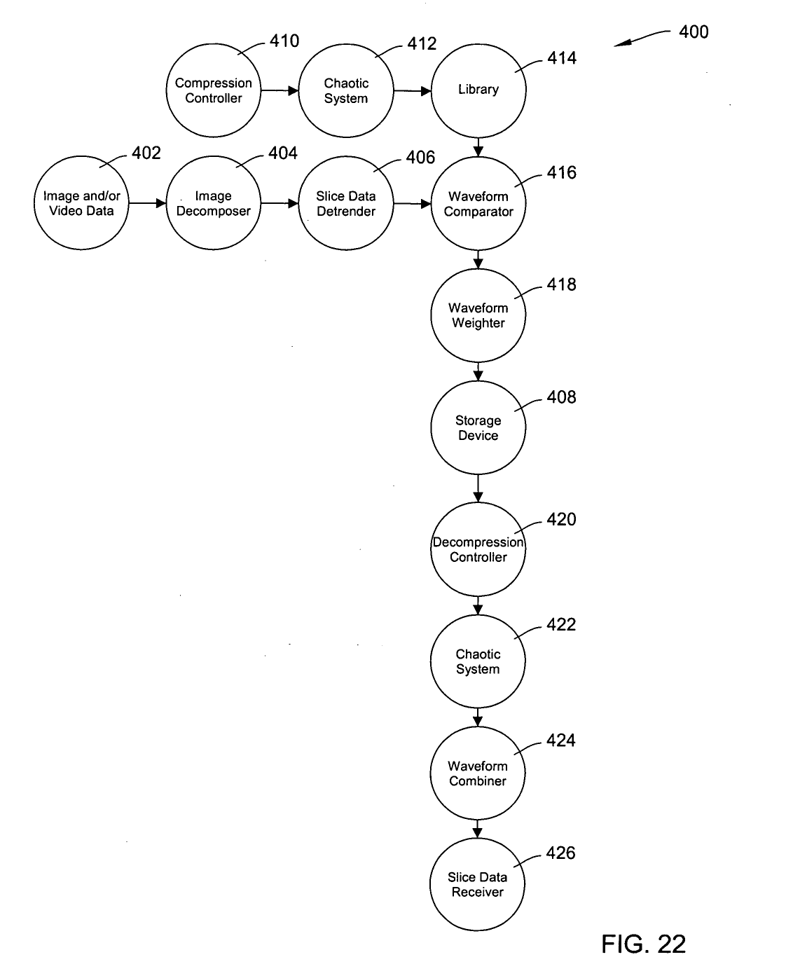

According to one feature of the .koz format, all of the layers are stored in a single master file on a server, and the content can be accessed at differing quality levels merely by extracting appropriate layers from the master file. This layering property enables the invention to provide improved quality of service (QoS) features on a network, because it means that when a network becomes busy and nears saturation, the number of layers taken from the master file can be reduced so that less bandwidth is required to transmit the content. Thus, a sufficiently high quality version of the content can be transmitted even when the network traffic is heavy, or when the network is nearly clogged. The layering property also facilitates a number of distribution modes discussed below. Similarly, in one embodiment, the files are naturally subdivided into blocks. By way of example, for audio data the blocks may be divided in time (described below, with respect to FIGS. 13-21), and for images and video (described below with respect to FIGS. 22-28), the blocks may be segments of the display, for example, one or more slices, raster lines, or blocks of an image.

### Preview Mode

According to one feature, the illustrative three-level model of DRM protection is adapted to allow for preview modes of distribution, as might be used for marketing promotions, for example. According to one illustrative embodiment, to distribute preview content, i.e., a preview-grade portion of the original content, the server extracts appropriate portions (e.g., layers and/or blocks) from the master file, and prepares the preview content for distribution.

In one embodiment, the extracted portions in the preview mode are selected so the quality of the preview content is noticeably inferior to the quality of the original content. In an alternative embodiment, the extracted portions in the preview mode are selected so the preview content has a quality substantially identical to the quality of the original content, but has a shorter duration; that is, the preview content may include a short time segment of the original content, for example, a short, but otherwise substantially unimpaired, segment of a musical performance.

The table of characteristics is then prepared, but is left unencrypted. The server can then freely distribute the preview content to any client device for playback, simply by sending the unencrypted table of characteristics along with the content component. Similarly, the preview package can be forwarded from one customer/client to other customers/clients, and the preview content can be freely reconstructed and played on any client device capable of processing the preview content.

According to another feature, the illustrative three-level model is adapted to support a mixed-mode of distribution, wherein content can be distributed in a hybrid package including a first component of promotional and/or preview content and a second component with DRM-protected quality-enhancement content that can augment the preview content to produce the full-quality original content. Illustratively, the freely-distributable preview component can include the appropriate layers or the appropriate blocks from the master file on the server, whereas the second component is locked to an individual client device and includes only those layers or blocks from the master file that are not included in the preview content.

To allow for this feature, two different tables of characteristics are prepared. The table of characteristics for the preview segment is unencrypted. The table of characteristics for the segment containing the high-quality enhancements is encrypted and locked to the client device. These two tables of characteristics provide a two-tier quality package. If the hybrid, two-tier package is forwarded to another client device or user, then the recipient can preview the content by using the unencrypted table of characteristics and the layers associated with the preview content. However, if the user operating the second client device wishes to access the full, high-quality version of the content, then, according to one feature, a secondary billing transaction is initiated to unlock the portion containing the high-quality enhancements. This will be described in more detail below, with regard to superdistribution.

### Superdistribution

To simplify the discussion of superdistribution, consider the files or streams in the DRM-enabled content delivery system as including two components, an encrypted component containing the table of characteristics and usage rights, and a component containing the transformed content. In one practice, these two components can be transferred as separate files. In an alternative practice, the two components can be bundled into a single file, with the header containing the encrypted component with the table of characteristics, or they can be combined into a single stream where the header of the transmission contains the encrypted component with the table of characteristics. In any of these formats, the client device needs both components to invert the transformation and reconstruct the original content. In essence, the usage rights are contained in the encrypted component, whereas the content resides in the second component.

Referring to the example of purchased multimedia content (e.g., audio, image, and/or tactile content) that has been downloaded to a client device, a model for superdistribution according to an illustrative embodiment of the invention can be summarized as follows. Assume the first customer has purchased the content and has stored it in the local memory on a first client device. The first user, wanting to share this content with a second user operating a second client device, transmits the content, for example, as an attachment, to the second client device.

If the second user attempts to use the content, client software detects that the encrypted table of characteristics cannot be decrypted by the second client device. In response, the second client device-generates a dialog box prompting the second user to contact the server to download a corrected (i.e., valid) encrypted component tailored for the second client device.

If the second user responds in the affirmative, then the second client device initiates a connection to the server, and the server then transmits the encrypted component containing the table of characteristics, except this time it has been encrypted for the second client device. In one practice, the host server encrypts content “on the fly” (i.e., in real-time) to the second client device. Ordinarily, though not necessarily, digital content resides at the server in unencrypted form. In one embodiment, when a client device requests the content from the server, the server can encrypt the content on the fly and transmit the encrypted content to the client device; in a particular implementation, the encrypted content is streamed to the client device.

The ability to transfer the table of characteristics in a small file means the network bandwidth is not impacted negatively. It also means that no obtrusive delays occur before the content can be used at the second client device, and the cost of transfer is low, relative to having to transfer the entire content. Hence, superdistribution is practical for the distributor, network operator, and user. At this time, the server also generates a billing event, including a billing record, and/or a record of the content transmitted to the second client device.

If the content forwarded from the first client device to the second client device is in the hybrid format described above, the recipient of the forwarded content (i.e., the second user) is able to play the content in a preview-mode, because the table of characteristics for the preview mode is not encrypted. Once the preview content is played, the second client device generates a dialog box prompting the second user to contact the server to download an encrypted component—uniquely associated with the second client device—containing the table of characteristics that unlocks the second component containing the quality-enhancement content. Optionally, any requisite authorization for particular uses of the content can be unlocked at this stage. If the response by the second user is in the affirmative, the second client device initiates a connection to the server, and the server then transmits the required encrypted components and generates a billing record.

In either scenario, once the transaction is completed to download the required encrypted component, the second client device can invert the transformation and reproduce the original content in full quality.

### Usage Management

Features of the invention also provide usage models for user rights support. Some of these include allowing only a single stream or one-time use of the content, granting perpetual rights to access content, granting a license for a restricted time of use for content, or for a limited number of uses of the content. The illustrative DRM architecture described herein can support any of these and other modes of use.

According to one illustrative embodiment, the invention employs buffer management to limit content use to a single stream or one-time use. More particularly, in this illustrative embodiment, the encrypted component containing the table of characteristics is transmitted at the beginning of a stream, and then the component containing the transformed content is loaded into a circular buffer. The data in the buffer is combined piece by piece with the decrypted table of characteristics to reconstruct segments of the original content. Since the buffer is circular, the data in the buffer is continually overwritten and, in any event, is substantially always in the transformed form; consequently, the data in the buffer cannot be stored or used after the streaming is completed, since the buffer may be in a protected part of the memory controlled by the client software.

According to one implementation, in response to a perpetual right being purchased, the component associated with the encrypted table of characteristics and the component associated with the transformed content are downloaded as complete files, or transmitted in a “stream-and-store” mode. In the stream-and-store mode, the component associated with the transformed content is loaded into a buffer. The component associated with the encrypted table of characteristics is stored in another buffer and is decrypted into a temporary memory space that does not persist after the streaming is completed.

As the data is streamed to the client, the original content is reconstructed and directed to an output interface, such as an image or video display, an audio speaker, a tactile interface generating, for example, a vibrational sensation, or a combination of these; however, the buffers only contain the encrypted data and the transformed content. When the streaming is completed, the buffers can be stored in persistent memory, without any loss of security, since the process of accessing the content requires decryption and inverse transformation of the content. In this manner, the content is locked to the client device, but can be accessed without further restriction by a user operating the second device.

Another variation on the “stream and store” mode is useful when the client device has limitations in processor speed or memory. In this variation, the client device may be capable of decompressing the content, but may not be capable of streaming and decrypting simultaneously. To overcome these limitations, one implementation of the invention prepares the content so that there is redundancy. The first streaming component is prepared as an unencrypted content file for streaming and immediate playback on the client device; however, the unencrypted file is only partially stored on the device—blocks or layers of the content are omitted from the stored, unencrypted component. While the first component is being streamed to the client, the server (which is usually a much more powerful computer) prepares the second, encrypted component of the content file. This second component contains all of the layers or blocks that are omitted from the storage stage of the streaming and playback portion of the transmission. Once the streaming of the first component is complete, the second component is transmitted to the client in the encrypted form and is stored along with the unencrypted, first component. Then, after the content is stored on the client device, if the user wants to play back the song, the two components, encrypted and unencrypted, are decrypted and reassembled to produce the file for playback. Since no streaming is occurring during local playback, the client device is likely to be able to decrypt and decompress in a manner that allows for uninterrupted playback.

If the content rights are granted for a fixed period of time, a period-of-use tag is included in the encrypted component of the package at the server, and the two components of the media are transmitted to the client device. Then, each time the content is accessed on the client device, a check is conducted to determine if the period-of-use tag remains valid. This is facilitated by referring to a system clock at the client device, as well as by cross-checking, and possibly even synchronizing, the clock at the client device and a system clock at the server, when the client device communicates with the server. As long as the period-of-use tag remains valid, the client device is able to decrypt the table of characteristics and recreate the content.

When the content rights are granted for a fixed number of accesses, a number-of-accesses tag is included in the encrypted component of the package at the server, and the two components of the media are transmitted to the client device. Then, each time the content is accessed at the client device, the number-of-accesses tag is checked to see if it is greater than zero. If the tag value is greater than zero, the decryption and reconstruction of the content is allowed to proceed, and the number-of-accesses tag is decremented by one and re-encrypted.

### Watermarking and Content Degradation

According to another feature, the invention provides watermarking and automatic content degradation. More particularly, according to the illustrative embodiment, the DRM technology described below includes an analysis stage wherein noise-like features in the content are altered out. To maintain a high-fidelity reproduction of the noise-like features, it is necessary to reproduce an accurate version of the frequency representation of the noise-like features. According to one practice, only the spectral phase portion of the frequency domain representation of the noise is altered to control degradation and watermarking.

In one embodiment, the original signal that bears data associated with the content is analyzed and decomposed into substantially periodic component signals and noise-like component signals; other components (e.g., transients and modulations) also may be used, though perhaps less frequently. In this embodiment, a highly accurate representation of the tone-like signals is created, but for the noisy signals an approximate magnitude spectrum component is created and attached to the complex phase information from a noise generator function, which can include a random number generator. In this practice, therefore, a randomized phase is used, which is, itself, just a component of the output of the noise generator. The phase information is generally not sent to the client device; rather, the client device reconstructs an equivalent phase model from the noise generator at the client device. Once the client device recreates a phase facsimile, the resulting noisy signal has substantially the same power spectrum as the original approximation of the noisy component of the original content; however, the noisy signal is randomized differently. It is randomized in a manner that should be undetectable; however, if the noisy phase is taken from an improperly initialized noise generator, the phase data will be inferior, thereby producing a recreated content of inferior quality.

The importance of noise in high-fidelity audio reproduction has been recognized by researchers, including Xavier Serra and Perry Cook, and described in the literature, including “Music, Cognition, and Computerized Sound—An Introduction to Psychoacoustics,” edited by Perry Cook, MIT Press, 1999 (see FIG. 16.5 on page 203).

This frequency spectrum can best be thought of as including spectral magnitudes and spectral phases. In general, the spectral phase information is chosen to resemble that of random noise. The creation of a random-noise-like component can be controlled so that a noise generator, which can include a noise-generating function, receives parameters, such as seed values or keys or taps; in one practice, these parameters initialize the noise generator, thereby determining whether the output of the noise generator is suitable or unsuitable.

For example, if a linear feedback shift register (LFSR) is used to generate the random signal that creates the random phase information, the LFSR can be structured so that when the authorized unique identifier is present, the LFSR produces a pseudo-random signal suitable for use as a noise-like component. If the unique identifier is absent, the LFSR defaults to a state producing quasi-periodic or periodic data (e.g., “short cycles”) unsuitable for use as a pseudo-random noise signal.

If the content is reconstructed without the proper pseudo-random component, then the reconstructed content suffers from degraded quality; for example, if the content is audio, the reconstructed audio may contain hissing or other audible undesirable artifacts. By ensuring that the proper unique identifiers are present only when proper payment has been made, the content owner is able to protect against unauthorized production, or reproduction, of high-quality digital copies of the content.

The noise-like features and the noise generating function can also be used for user-specific watermarking of content. Since the noise generator is taken from broad categories of functions, for example, the LFSR functions described above, it is possible to define a default function within the broad category that is unique for a particular user.

For example, in an LFSR, each user may be given a distinct set of default values for the taps. In the event of a user making an unauthorized copy of a portion of digital content and, for example, making the unauthorized content freely available on the Internet, the unauthorized content may be forensically analyzed to find the associated noise generator and initializing parameters, and, hence, the user responsible for the illegal transfer of the copy of the content. Thus, users who share the protected content without authorization, can be more easily identified and stopped.

### ILLUSTRATIVE EXAMPLE

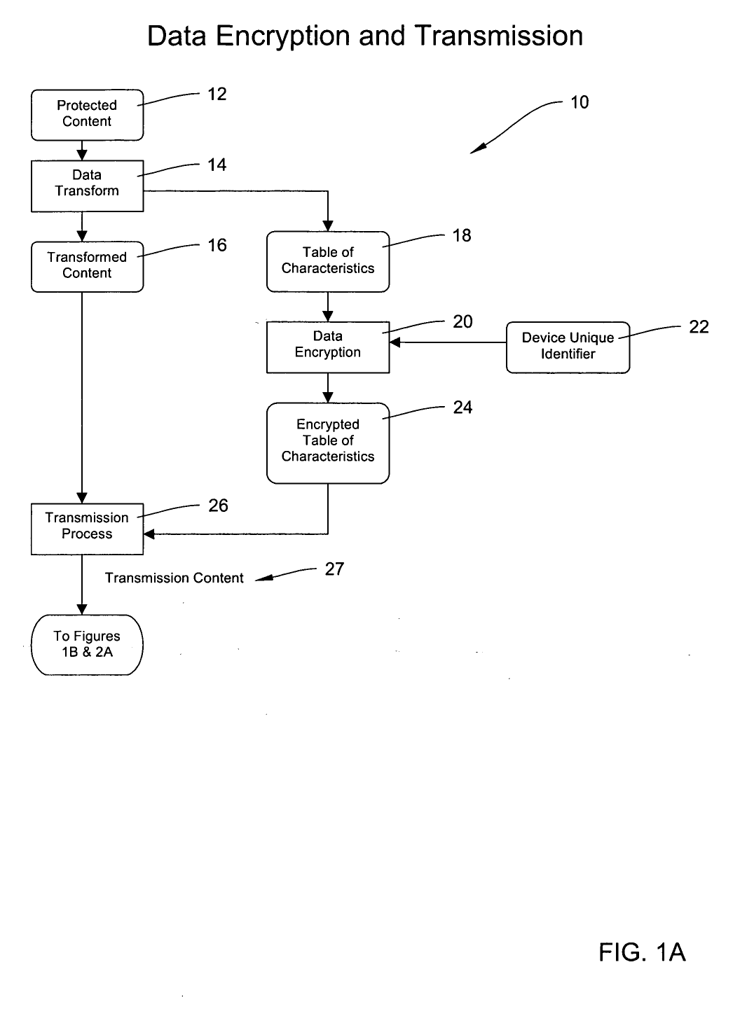

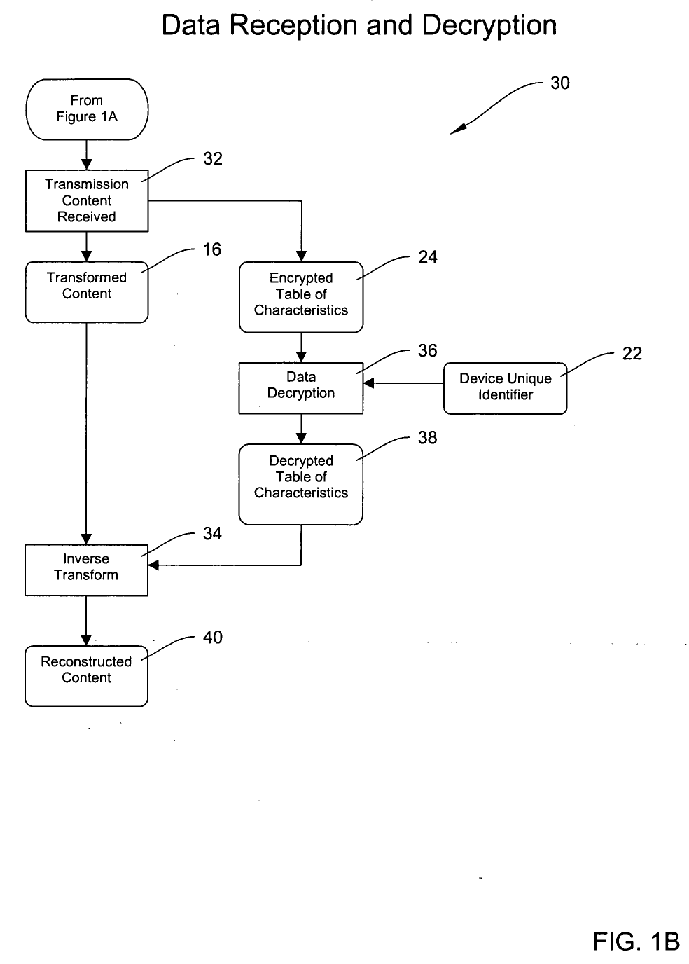

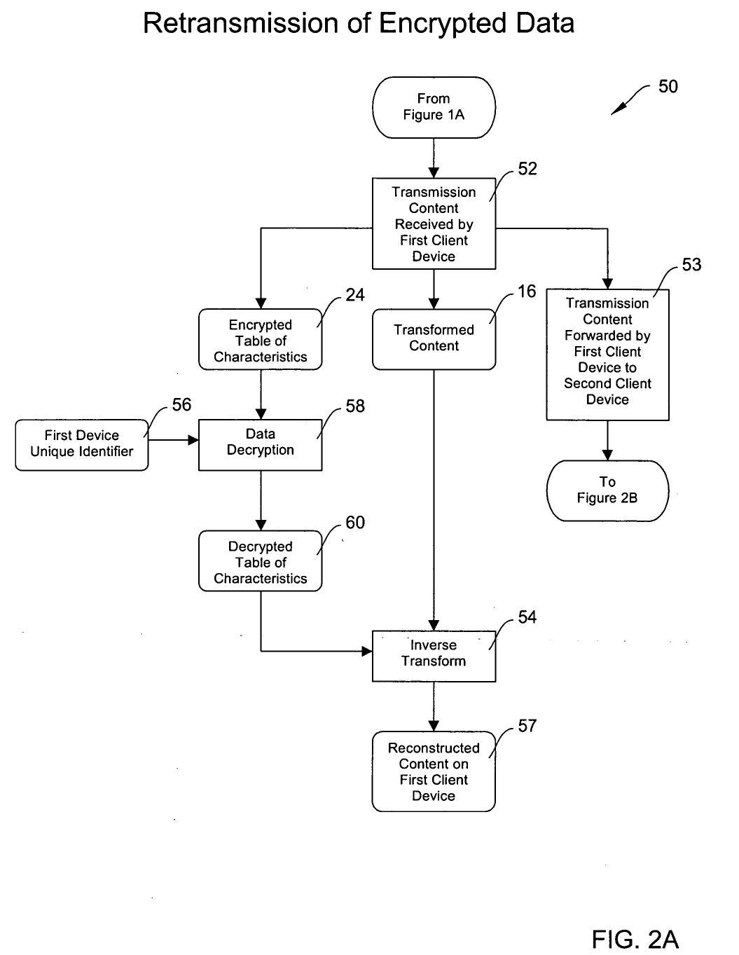

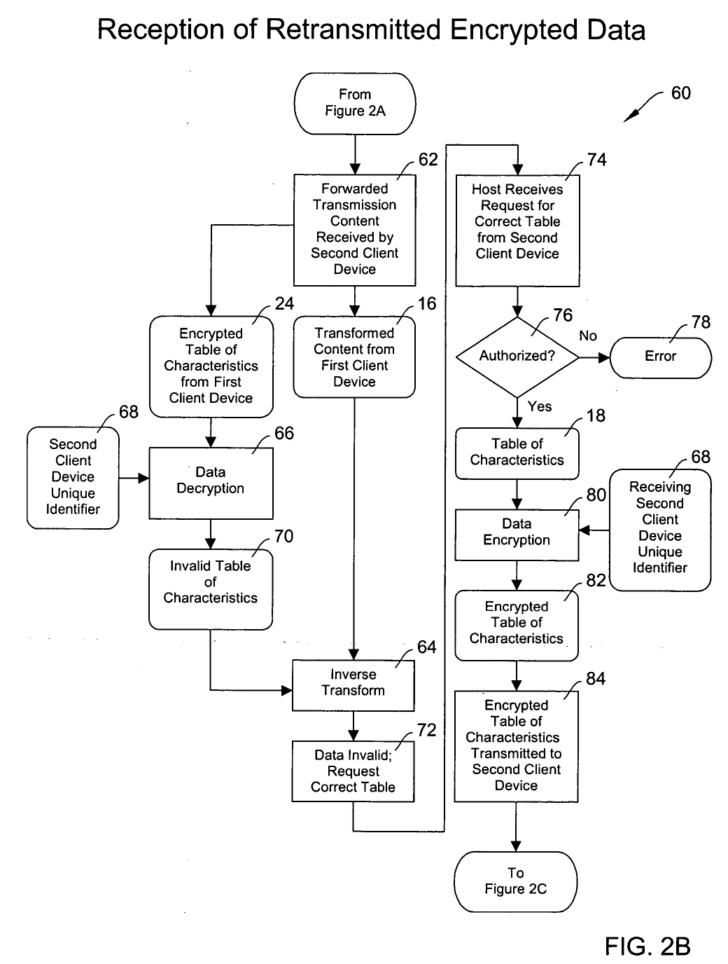

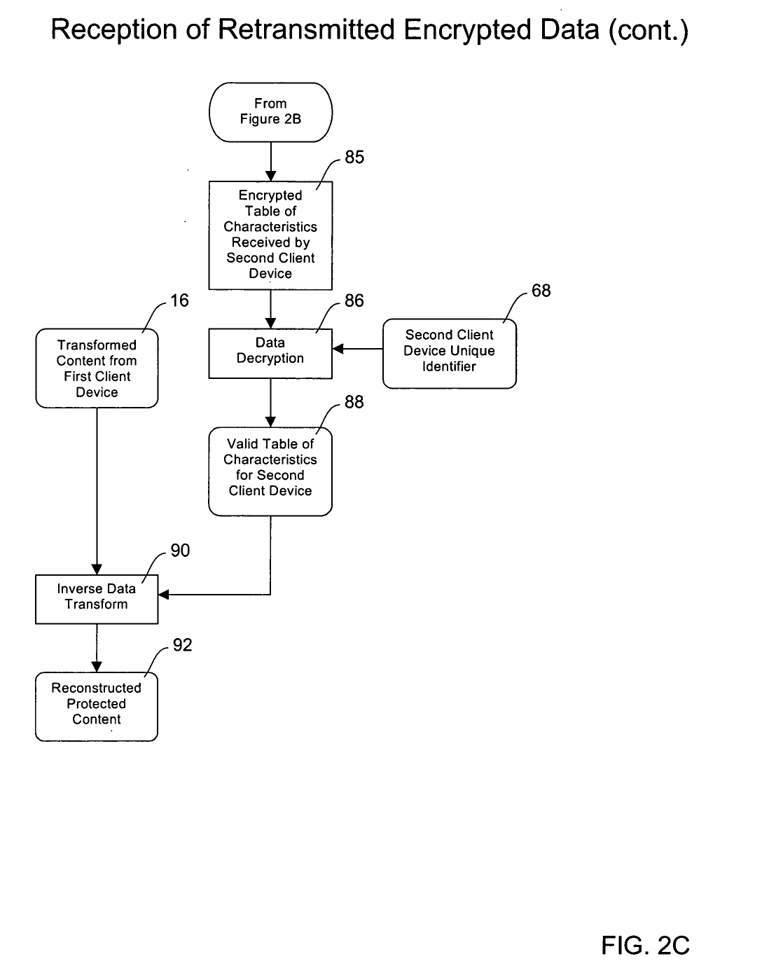

The DRM systems and methods described above can be understood in more detail by reference to FIGS. 1A-2C, which provide flow diagrams of several illustrated processes according to the invention. Turning to FIG. 1A, an illustrative process 10 for data compression, encryption and transmission is presented. As shown in FIG. 1A, the process begins at 12 with identifying and selecting protected content. The protected content can be, for example, any digital content. The content may be, for example, in a compressed format, such as a .koz compressed file, or an MP3 file of an audio recording, or other-audio content such as a ring tone or customizable caller alert for a mobile telephone. As a matter of reference, the .koz format is publicly available, among other places, at www.chaoticom.com. Alternatively, the content can be an image file such as a screensaver, a photo, a logo, or other image content; a video file; a text file, including, but not limited to, an e-book; a Java game or other kinds of game software; any executable software; or any other kind of digital file. Once the protected content is selected, a data transform process takes place at 14, as described below beginning with reference to FIG. 3.

As described above, the original content is transformed into a representation 16, a transformed content, distinct from the original protected content. For example, the raw sample data of a caller alert is transformed in the encoding process so that the original caller alert can be derived only by application of an inverting transformation process.

As further shown in FIG. 1A, the data transform process also creates a table of characteristics 18. The table of characteristics 18 is produced by the transform process, and in one embodiment is optimized, or at least partially based on, the characteristics of the protected content. The table of characteristics can be, for example, a custom Huffman-coding table, or it may be a standard coding table such as an Arithmetic coding table, or based on another lossless coding method.

In a preferred embodiment, the custom coding tables are structured to take advantage of the characteristics of the compressed format. For instance, the common use of fixed Huffman coding tables is inefficient for media content such as music, so custom coding tables can be developed to provide a greater degree of compression. According to one feature, the invention recognizes that the parameters needed for the reconstruction of the content can be treated individually, since the statistics of different parameters can very widely, end customizes the tables to minimize the number of states in a histogram of the data. Further improvement is achieved by replacing some parameters by delta-coded representations of the parameters, or some hybrid combination of parameters and delta-coded parameters. The parameters for replacement are selected to reduce or minimize the memory footprint of the custom the tables. Employing this approach reduces the latency or buffering delay in streaming the content by a significant factor, such as up to about 66% in one embodiment.

As shown in FIG. 1A, the table of characteristics 18 is presented to a data-encryption algorithm 20. In addition, an identifier 22 uniquely associated with a client device (not shown) is also presented to the data encryption algorithm 20. The device unique identifier 22 may be used to generate a digital encryption key; alternatively, the identifier itself may be used as an encryption key. In either case, the data encryption process 20 employs the device unique identifier 22 to encrypt the table of characteristics 18.

The encrypted table of characteristics 24 and the transformed content 16 are then passed to a transmission process 26; the transmission process 26 transmits a transmission content 27 including the encrypted table of characteristics 24 and the transformed content 16 to the client device. The client device may be at a remote location; nevertheless, the device unique identifier 22 is available at the client device, and need not be transmitted to the client device. At the client device, a data reception and decryption process may be carried out.

FIG. 1B depicts one example of such a data reception and decryption process 30. As shown in FIG. 1B the transmission content 27 is received at 32, and the transformed content 16 and encrypted table of characteristics 24 are separated. The transformed content 16 is sent to an inverse transform process 34, and the encrypted table of characteristics 24 is sent to a data decryption process 36. The data decryption process 36 employs the device unique identifier 22 to decrypt the encrypted table of characteristics 24. As described in more detail below beginning with FIG. 3, the decrypted table of characteristics 38, which should be identical to the table of characteristics 18, is sent to the inverse transform process 34 to enable the inverse transform process 34 to produce a reconstructed content 40 from the transformed content 16.

According to the illustrative embodiment, the unique identifier may be, for example, a phone number on a wireless telephone handset, an EIN, an MIN (Mobile ID Number), an MSISDN number, a serial number, a number associated with a SIM (Subscriber Identity Module) card, an IMEI (International Mobile Equipment Identifier) number, any number on an SD card or MMC card, an ESN (Electronic Serial Number), an IMSI (International Mobile Subscriber Identification) number, a private encryption key for a public/private key encryption process, a proprietary identifier created for this system, or any other identifier that provides a unique identifier for the receiving device.

In some embodiments, the systems and methods described herein can deliver content across the Internet from a server to the client device. In these embodiments, the client device may have a unique ID address that can be used as the unique identifier for encrypting and decrypting the table of characteristics. The unique identifier may also be the MAC address of the modem associated with the client device. As the receiving device can have a unique identifier, the transmitting device needs access to that unique identifier so that the encryption process 10 can create the encrypted table of characteristics 24 that can be decoded 30 by the receiving device.

According to one illustrative embodiment, the transmitting device can access a key table that stores keys associated with devices or individuals known to the service. The key table can be, for example, a database that stores information representative of a subscriber's account, including unique identifiers, passwords, user accounts, user privileges and similar information. The database may include any suitable database system, including commercially available Microsoft and Oracle databases, and can be a local or distributed database system. The design and development of database systems suitable for use with the system, follow from principles known in the art, including those described in McGovern et al., “A Guide To Sybase and SQL Server,” Addison-Wesley (1993). The database can be supported by any suitable persistent data memory, such as a hard disk drive, RAID system, tape drive system, floppy diskette, or any other suitable system.

FIG. 2A depicts a process 50 for retransmitting the transmission content 27 produced by the transmission process 26 from a first client device (e.g., the receiving device in FIG. 1B) to a second client device. The process 50 begins after the transmitting device has sent the transmission content 27 to the first client device. The transmission content 27 is received at 52 by the first client device. Again, the encrypted table of characteristics 24 and the transformed content 16 can be separated. However, as shown in FIG. 2B, the data 53 transmitted from the first client device to the second client device can also be separated out.

At the first client device, the transformed content 16 is sent to an inverse transform process 54. The encrypted table of characteristics 24 is decrypted at 58 using the unique identifier 56 associated with the first client device. The decrypted table of characteristics 60 and the transformed content 16 are applied to the inverse data transform process 54. This results in the reconstructed content 57 on the first client device.

Referring also to the process 60 of FIG. 2B, the transmission content 53 forwarded from the first client device is received by the second client device at 62. The forwarded transmission content 62 is routed so that the transformed content 16 from the first client device is sent to the inverse transform process 64 running on the second client device. The encrypted table of characteristics 24 is separated out from the forwarded transmission content 62, and passed on to a data decryption process 66. In this case, the data decryption process 66 attempts to use a unique identifier 68 associated with the second client device to decrypt the table of characteristics 24.

As shown at 70, this results in an invalid table of characteristics. Optionally, the process 66 may fail here, or it may proceed to a later step where failure is detected if the decryption process is unsuccessful. The method of detecting the validity of the table of characteristics or decrypted content can vary according to the application, and can include standard techniques including verifying check sums or looking for control words or keywords that are expected to appear at certain locations within the table or the content.

In any event, once the table of characteristics is deemed invalid, the process then moves on to the inverse data transform process 64, where the transformed content 16 and the invalid table of characteristics 70 are employed and an attempt is made to reconstruct the original protected content 12. As shown at 72, this results in invalid data being generated. Upon detection of this invalid data, the system generates and sends to the host a request for the correct table of characteristics. At 74 the host receives the request for the correct table of characteristics from the second client device. The process 60 then enters a decision block 76, to determine whether the second client device is authorized to receive this table of characteristics. If the second client device is deemed not authorized, then the system detects an error and terminates at 78. Alternatively, if the second client device is authorized, the host encrypts at 80 the table of characteristics 18 using the second client device unique identifier 68. This encrypted table of characteristics 82 is then transmitted by 84 to the second client device.

Turning to FIG. 2C, the encrypted table of characteristics is received 85 by the second client device. The process 60 then proceeds at 86 to decrypt the received encrypted table of characteristics 85 using the identifier 68 uniquely associated with the second client device to create a valid table of characteristics 88. This valid table of characteristics 88 is then passed to the inverse transform process 90, which uses the valid table of characteristics 88 to reconstruct the original content 92 at the second client device.

As mentioned above, the systems and methods of the invention may be employed with any suitable encryption, decryption, compression and decryption processes. However, according to one embodiment, the systems and methods of the invention employ one or more chaotic systems to facilitate encryption, decryption, compression, and/or decompression. Illustrative encryption, decryption, compression and decompression approaches will now be described, which enable the features of the invention, discussed above, to be implemented.

The systems and methods of the invention take advantage of two characteristics of chaotic systems. The first characteristic is that the trajectory of a chaotic system visits different regions of the system over time. If the different regions of the system are labeled 0 or 1, a seemingly random bitstream will be generated by the trajectory, as is described in more detail below. Controls can also be imposed on a chaotic system to cause it to generate a specific bitstream.

The second characteristic is that certain controls may be used as initialization codes, as also described in more detail below, to synchronize two or more identical chaotic systems. The synchronized chaotic systems then generate identical bitstreams.

In one embodiment, the chaotic system employed by the invention is a double-scroll oscillator (S. Hayes, C. Grebogi, and E. Ott, “Communicating with Chaos,” Phys. Rev. Lett. 70, 3031 (1993)), described by the differential equations:
C₁\dot{v}_{C1}=G(v_{C2}−v_{C1})−g(v_{C1})
C₂\dot{v}_{C2}=G(v_{C1}−v_{C2})+i_{L}
Li_{L}=−v_{C2}
where

$$g ( v ) = \{ \begin{matrix}{m}_{1} v & if - {B}_{p} \leq v \leq {B}_{p} \\ {m}_{0} ( v + {B}_{p} ) - {m}_{1} {B}_{p} & if v \leq - {B}_{p} \\ {m}_{0} ( v - {B}_{p} ) + {m}_{1} {B}_{p} & if v \geq {B}_{p} \end{matrix}$$

The attractor that results from a numerical simulation using the parameters C₁=1/9, C₂=1, L=1/7, G=0.7, m₀=−0.5, m₁=−0.8, and Bₚ=1 has two lobes, labeled 0 and 1, with each lobe surrounding an unstable fixed point, as shown in FIG. 3.

Due to the chaotic nature of this oscillator's dynamics, it is possible to take advantage of sensitive dependence on initial conditions by carefully choosing small perturbations to direct trajectories along each of the lobes of the attractor. In this way, steering the trajectories along the appropriate lobes of the attractor, suitably labeled 0 and 1, can generate a desired bitstream. It should be noted that other embodiments could have more than two lobes, in which each lobe is labeled 0 or 1 or a symbol from any chosen symbol set.

There are a number of ways to control the chaotic oscillator in this embodiment, to specify the bits 0 and 1 more precisely. In an alternative embodiment, a Poincare surface of section is defined on each lobe by intersecting the attractor with the half planes i_{L}=±GF, |v_{C1}|≦F, where F=Bₚ(m₀−m₁)/(G+m₀), and a type of Poincare map can be defined to map one intersection point of a trajectory to the next intersection point on the surface of section.

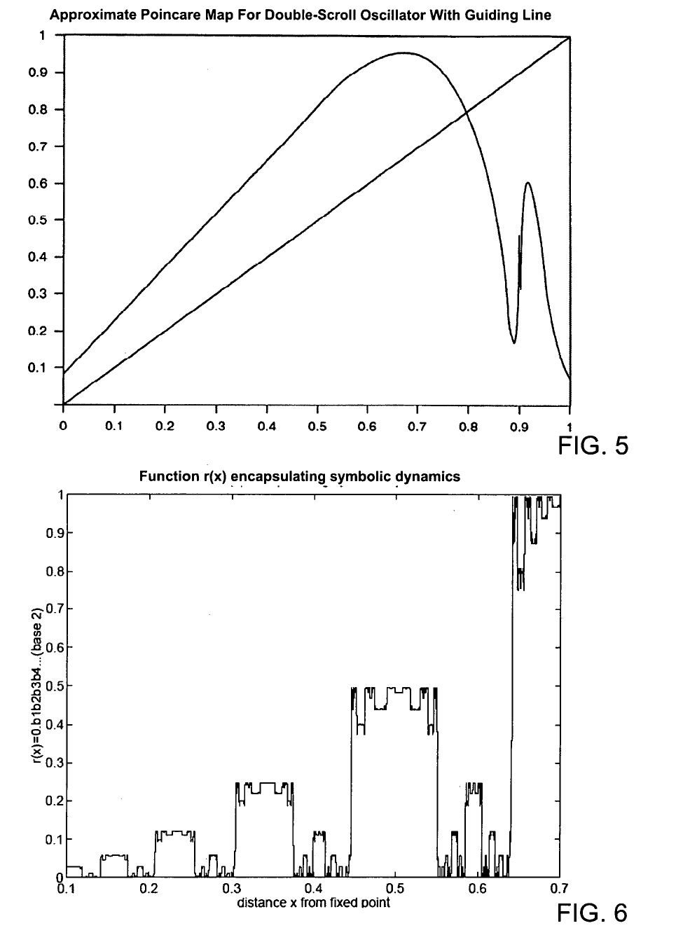

FIG. 5 is a plot of a Poincare Map for the double scroll oscillator of FIG. 3. When a trajectory intersects one of these sections, the corresponding bit can be recorded. Then, a function r(x) is defined, which takes any point on either section and returns the future symbolic sequence for trajectories passing through that point. If I₁, I₂, I₃, . . . represent the lobes that are visited on the attractor, and the future evolution of a given point is such that x₀→I₁, I₂, I₃, . . . for some number N of loops around the attractor, then the function r(x) is chosen to map x to an associated binary fraction, so r(x₀)→0.I₁ I₂ I₃ . . . I_{N}, where this represents a binary decimal (base 2). Then, when r(x) is calculated for every point on the cross-section, the future evolution of any point on the cross-section is known for N iterations. The resulting function is shown in FIG. 6, where r(x) has been calculated for 12 loops around the attractor, i.e., N=12.

Control of the trajectory begins when it passes through one of the sections, for example, x₀. The value of r(x₀) yields the future symbolic sequence followed by the current trajectory for N loops. If generation of a desired bitstream requires a different symbol in the Nth position of the sequence, r(x) can be searched for the nearest point on the section that will produce the desired symbolic sequence. The trajectory can be perturbed to this new point, and it continues to its next encounter with a surface. This procedure can be repeated as many times as desirable.

It should be noted that this embodiment exhibits a “limited grammar,” which means that not all sequences of 0's and 1's can be directly encoded, because the chaotic oscillator always loops more than once around each lobe. Consequently, a sequence of bits such as 00100 is not in the grammar, as it requires a single loop around the lobe labeled 1. A remedy is to repeat every bit in the code or append a 1- or a 0-bit to each contiguous grouping of 1- or 0-bits, respectively. Other embodiments may have a different grammar, and examples exist where there are no restrictions on the sequence of 0's and 1's. For this system, the bitstream is read from the oscillation of coordinate i_{L}, so the bitstream is read from the peaks and valleys in i_{L} (there are small loops/minor peaks that occur as the trajectory is switching lobes of the attractor, but these are ignored.)

The calculation of r(x) in the embodiment was done discretely by dividing up each of the cross-sections into K partitions (“bins”), where K was chosen to be 2001, but could have been chosen to be a different number, and calculating the future evolution of the central point in the partition for up to 12 loops (the number of loops does not need to be limited to 12) around the lobes. As an example, controls were applied so that effects of a perturbation to a trajectory would be evident after only five loops around the attractor. In addition to recording r(x), a control matrix M was constructed containing the coordinates for the central points in the bins, as well as instructions concerning the controls at these points. These instructions simply prescribe how far to perturb the system when it is necessary to apply a control. For example, at an intersection of the trajectory with a cross-section, if r(x₀) indicates that the trajectory will trace out the sequence 10001, whereas the sequence 10000 is desired, then a search is made for the nearest bin that will produce the desired sequence, and this information is placed in M. If the nearest bin is not unique, then, according to one feature, there is an agreement about which bin to take—for example, the bin farthest from the center of the loop. Because the new starting point after a perturbation has a future evolution sequence that differs from the sequence followed by x₀ by at most the last bit, only two options need be considered: apply a control or apply no control.

The matrix M holds the information about which bin should hold the new starting point for the perturbed trajectory. In a hardware implementation, the perturbations are applied using voltage and/or current variations; in a mapping-based hardware implementation, the perturbations are contained in a look-up table and result in a variable replacement in the mapping function. In an illustrative software implementation, the control matrix M is stored along with the software computing the chaotic dynamics, so that when a perturbation is required, the information can be read or inferred from M.

A further improvement involves the use of microcontrols. Each time a trajectory of a chaotic system passes through a cross-section, the simulation is backed-up one time step, and the roles of time and space are reversed in a Runge-Kutta solver—or some other suitable numerical method used for solving differential equations—so that the trajectory can be integrated exactly onto the cross-section without any interpolation. Then, at each intersection where no control is applied, the trajectory is reset so that it starts at the central point of whatever bin it is in. This resetting process can be considered the imposition of microcontrols. It serves to remove accumulation of round-off error, and reduces the effects of sensitive dependence on initial conditions. It also has the effect of restricting the dynamics to a finite subset of the full chaotic attractor, although the dynamics still can visit the full phase space. These restrictions can be relaxed by calculating r(x) and M to greater precision at the outset.

Another embodiment of a chaotic system utilizes an approximate one-dimensional Poincare map, as in FIG. 5. The Poincare section has two branches, one on each lobe of the attractor. The partitioning of the surface and the use of microcontrols allow one to calculate easily a map that exhibits all of the symbolic dynamics of the full microcontrolled system. The evaluation of this map is generally simpler and faster than integrating between intersections with the surface of section. To find the map, one can take the center point in each bin as an initial condition (since these are the points to which the microcontrols “reset” trajectories), integrate forward in time until the next intersection with either branch of the surface of section, and note the branch and bin in which the trajectory landed. For a given set of integration parameters (time step, method, etc.) and for a given partition of the surface of section, the trajectory from the center of any bin to its next intersection with the surface will not vary substantially; it is recognized that a computation performed on a different computer may cause insubstantial numerical differences that can be ignored. Therefore, the map mimics closely the behavior of the microcontrolled system for the given integration method.

To implement this map, two more columns are placed in the control matrix M: one containing the row number in M corresponding to the next intersection for all K bins, and the other containing the next lobe under the map. Simulated data transmission and reception using this new matrix is essentially the same as transmission and reception using integration.

For a given bin on the section and for a given message bit, the transmitter-encoder still uses the function r(x) to compare the symbolic dynamics N bits in the future. If the N-th bit in the future dynamics for that bin differs from the current message bit, r(x) is used to find the nearest bin that would produce the desired sequence. Then the map is used to find the location of the next intersection with the surface, and the process is repeated with the next message bit. The use of this map eliminates time-consuming numerical integration, allowing for faster and more extensive processing.

The above map differs from a conventional Poincare map in a couple of aspects. First, while the Poincare section is two-dimensional, it is approximated with a pair of lines extending from the unstable fixed points fitted with a least-squares method. Whenever a trajectory intersects the section, by only considering the distance from the corresponding fixed point, the point of intersection is essentially rotated about the fixed point onto the line, before proceeding. Therefore, the three-dimensional dynamic system is reduced to a one-dimensional map. Second, the point is reset to the center of its current bin to simulate the microcontrols. Theoretically, letting the maximum length of the intervals in the partition go to zero makes this second approximation unnecessary.

The use of a Poincare map allows a generalization of the system to any chaotic one-dimensional map. It is simply a matter of defining “lobes”—what section of the domain implies a switching of bits, recording the symbolic dynamics in r(x), and finding appropriate controls as described above. For example, one could take the logistics map xₙ=axₙ₋₁(1−xₙ₋₁) and somewhat arbitrarily say that for any xₖ≧x lobe, where 0<x_{lobe}<1, the current bit bₖ will be 1−bₖ₋₁: -otherwise, bₖ=bₖ₋₁. This gives the symbolic dynamics to build a system, and this freedom improves the mapping in at least two ways. First, maps can be chosen that have no grammar restriction, which eliminates the need to adjust the bitstream to comply with the system's dynamics. Second, it is possible to fine-tune the maps to optimize the system statistically.

To eliminate the restriction that bits must at least come in pairs, the map can allow trajectories to remain in the “switching” region for two or more iterations in a row. For example, one can use the second iterate of the logistics map, xₙ=a²xₙ₋₁(1−xₙ₋₁)(1a−xₙ₋₁(1−xₙ₋₁)), with a=3.99. To preserve the symmetry, it is logical to choose x_{lobe}=0.5. All short binary words are possible in the natural evolution of this map, so there are no grammar restrictions with this system.

In another embodiment, starting with the chaotic system described above, rather than labeling the lobes of the chaotic system, one can label the control bins on the control surfaces. The bins can be labeled 0 or 1, or each bin can be assigned a symbol from any chosen symbol set. Then a bitstream is generated by the trajectory of the chaotic system. The trajectory of a chaotic system can be used in many ways to generate a bitstream. For example, using the chaotic system described above, one can track the intersections of the trajectory with the control surfaces, compare the i^{th} intersection with the (i+1)^{th} intersection, and use a distance measure between the bins in which the intersections occurred to form an information string, which can be converted to a bit string. For instance, if the distance measured is fourteen bins, the binary string for fourteen is an information string. As another example, one can apply a threshold to the amplitudes of the oscillations of the trajectory. Whenever an oscillation is above the threshold, a 1-bit is generated and whenever an oscillator is below the threshold, a 0-bit is generated, resulting in a bitstream. Alternatively, multiple amplitude thresholds can be set using combinations of 1-bit and 0-bit labels for each threshold.

Two or more identical chaotic systems, such as those described above in the various embodiments, can be driven into synchrony by the use of an initialization code. It is possible to apply an initialization code, including a sequence of controls, to each of the chaotic systems, driving each of the systems onto respective periodic orbits that are identical. Once on the periodic orbit, an additional control, for example, in the form of an additional control bit, applied to a chaotic system will cause the system to leave the periodic orbit and generate a bitstream as described in detail above.

When microcontrols are used, as described above, a chaotic system can assume a finite number of periodic orbits, so periodicity of the chaotic system is eventually guaranteed under a repeating sequence of controls. More importantly, the chaotic system can be driven onto a periodic orbit by applying to it a repeating code. Distinct repeating codes lead to distinct periodic orbits. The periodic orbit reached is dependent primarily on the code segment that is repeated, and not on the initial state of the chaotic system (although the time to get on the periodic orbit may vary, depending on the initial state). Consequently, it is possible to apply an initialization code to two identical chaotic systems and drive them onto the same periodic orbit.

There are numerous control sequences that, when repeatedly applied, lead to a uniquely associated periodic orbit assumed by the chaotic system. However, for some control sequences, the uniquely associated periodic orbit depends on the initial state of the chaotic system. Accordingly, repeated control sequences can be divided into two classes, initializing codes and non-initializing codes. An initializing (or initialization) code is a code whose uniquely associated periodic orbit does not depend on the initial state of the chaotic system. That is, an initialization code drives the chaotic system to the same periodic orbit for any number of distinct initial states.

The length of each periodic orbit is an integer multiple of the length of the repeated control sequence. This is natural, since periodicity is attained when both the current position on the cross-section and the current position in the control sequence are the same as at some previous time. As described herein, any control codes correspond to orbits that can be stabilized and utilized using a smaller possible substring of the control code, since the full control code can be viewed as an integer multiple of the substring code. To guarantee that the chaotic system is on the desired periodic orbit, it is sufficient for the period of the orbit to have the length of the smallest repeated segment of the initialization code.

The number of initialization codes has been compared with the number of bits used in the initialization code, and the number of initialization codes generally grows exponentially to the number additional bits. This is a desirable result, as it means that there are many periodic orbits from which to choose. As an example, the compressed initialization code 01011 was repeated for the double-scroll oscillator of FIG. 3. As a result, the chaotic dynamics of FIG. 3 are driven onto the periodic orbit shown in FIG. 4. This periodic orbit is stabilized by the application of the control code.

Chaotic systems can be implemented entirely in software. The chaotic systems in one such implementation are defined by a set of differential equations governing the chaotic dynamics, for example, the double scroll equations described above. An algorithm is used to simulate the evolution of the differential equations, for example, the fourth-order Runge-Kutta algorithm. In a second software implementation, mappings, instead of differential equations, can be used to define the chaotic systems. In this case, the chaotic systems are defined to take an input value and produce an output value.

Chaotic systems can also be implemented in hardware. The chaotic systems are still defined by a set of differential equations, but these equations are used to develop an electrical circuit that generates the same chaotic dynamics. The procedure for conversion of a differential equation into an equivalent circuit is well-known and can be accomplished with a combination of electrical circuit components such as resistors, capacitors, inductors, operational amplifiers, multipliers, and other devices known in the art, arranged according to suitable network configurations having the necessary feedbacks. The control information is stored in a memory device, and effecting a variation in a voltage or in a current of the circuit constitutes applying a control. In a second hardware implementation, a mapping function is converted into a look-up table that can be stored on a digital memory chip, along with a table containing the control information. Data is compressed by using the look-up table to generate the chaotic dynamics.

A chaotic system can also be implemented by a configuration of optical devices such as lasers. In this implementation, a set of differential equations is approximated by one or more optical devices. Once the approximate system is developed, it defines the chaotic systems. Control surfaces, partitions, and microcontrols are defined for the chaotic dynamics realized by the optical system, for example, the laser system. The laser is driven into a chaotic mode of oscillation, and controls are developed using, for example, the occasional proportional feedback (“OPF”) technique [E. R. Hunt Phys. Rev. Lett. (Phys. Rev. Lett.) 67, 1953 (1991)]. The control information is stored in a memory device containing information defining the required controls for both the full controls and the microcontrols, as described above. The microcontrols are applied by using, for example, OPF controls to drive the chaotic dynamics toward the center of the partitions on the control surfaces.

### Illustrative Compression Systems and Methods

The ability to drive a chaotic system onto a periodic orbit allows for lossless digital data compression. Since each periodic orbit is created by, for example, a 16-bit code, there is a mapping between the 16-bit code and the information produced by the periodic orbit. Using a number of different techniques, the orbit can be converted into a binary string of bits, and these binary strings can be used as building blocks to recreate strings of data, either by direct substitution of the chaotically-created bit string for the original digital data, or by recombining several chaotically-created bit strings to recreate the original digital data. Once the original digital data has been recreated, the chaotically-created bit strings can be replaced by the 16-bit codes to achieve the data compression. The process to recreate the original digital data can be implemented, in one embodiment, through the following steps:

A chaotic system is selected. The chaotic system can be a chaotic map or a continuous chaotic flow. A chaotic control scheme is imposed. Control strings of p-bits are used to create periodic orbits.

A rule for conversion to a binary string of bits is selected. Many possible rules are available, with the only requirement being that the dynamics are converted into a binary string of bits.

A section of the original data is recreated by substituting the chaotically-created binary strings of bits, or by recombining the chaotically-created binary strings of bits. An illustrative approach for recombination is to perform modulo-2 addition of the chaotically-created binary strings of bits so that the sum is equal to the original digital data. Then the control strings that generated the chaotically-created bits are saved.

The recreation process continues for the next section of the original data, and so forth, until all of the data has been processed and compressed.

The size of the section of the original data compressed can be varied to achieve a high compression ratio. The illustrative algorithm first attempts to take a long section of data and recreate it by chaotically produced binary strings. If a high compression ratio is not achieved, the algorithm then attempts to take smaller sections of data until an acceptable compression ratio is found.

Many control codes correspond to orbits that can be stabilized and employed using a smaller substring of the control code, since the full control code can be viewed as an integer multiple of the substring code. Thus, the substring initializing code may be repeated twice, thrice, or by greater integer multiples before the trajectory repeats itself. Periodicity implies that the orbit is in the control bin that corresponds to a given position in the control code; it is just that the substring control code may have been used an integer number of times already.

An example can be used to clarify this. Consider a substring control code such as 10110, and an extended version 101101011010110. The extended version results from repeating the substring control code three times, and may correspond to an orbit as described before, having period fifteen; however, the substring control code 10110 may be taken without extension by merely repeating it until periodicity is established.

These orbits can be used in a compression scheme, as long as there is an accompanying protocol to establish a starting position. One rule that works is to start the orbit at the position of the innermost intersection with the control surface. Many other rules can be used, but the important point is to establish a mapping between a substring of control bits and an orbit that may be of a length equal to an integer multiple of the number of substring control bits. Substring control bits can produce a compression of the message bit strings, because substring control bits can map to longer trajectories, and these longer trajectories map out message bit strings.

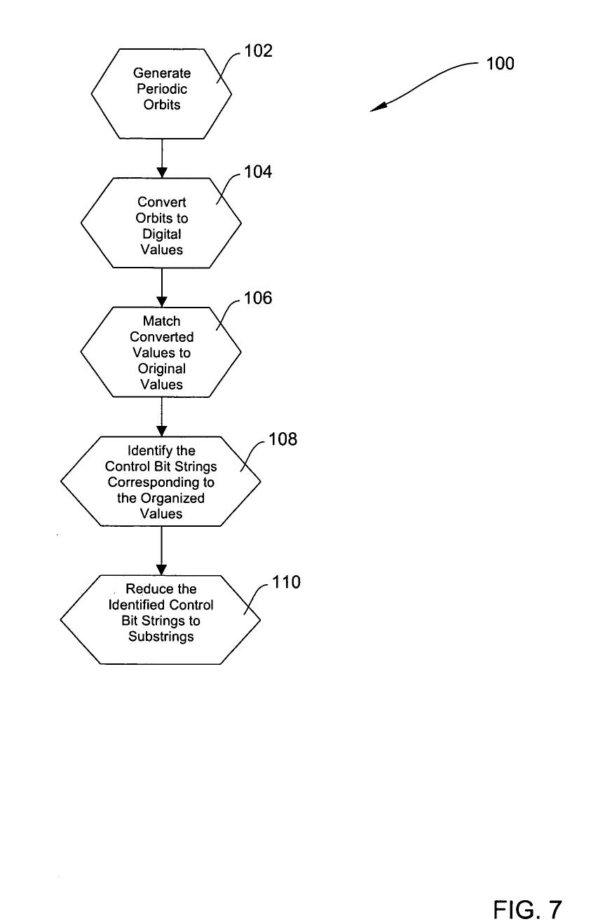

FIG. 7 depicts method 100 for compressing digital content according to one illustrative embodiment of the invention. The data includes strings of digital values, which can be broken down to a binary series of 1's and 0's. The method 100 uses a chaotic system to compress the data. The first step in method 100 is generating 102 a plurality of periodic orbits that correspond to a plurality of control bit strings. Each of the periodic orbits is formed with a series of numeric values. The next step is to convert 104 the numeric values of the periodic orbits to digital data values, similar in form to the data to be compressed. The digital data values of the periodic orbits are then identically, or nearly identically, matched 106 to the original digital data values. Then, the control bit strings corresponding to the matched 106 digital data values of the periodic orbits are identified 108, such that applying the control bit strings to the chaotic system would regenerate the original data. Illustratively, the final step involves reducing 110 at least one of the control bit strings in the plurality of control bit strings to a smaller substring. The smaller substring is then used in lieu of the corresponding control bit string. Preferably, a substantial number of the control bit strings are reduced, but some control bit strings may be irreducible.

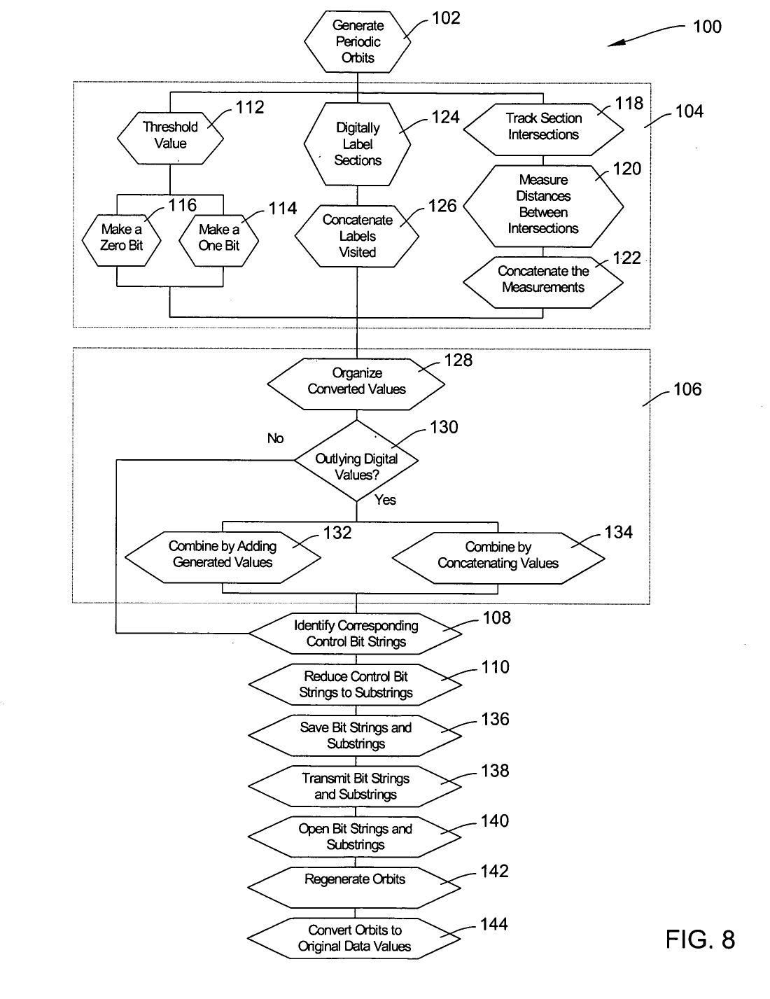

FIG. 8 provides a more detailed flowchart for the process 100 depicted in FIG. 7, according to one illustrative embodiment of the invention. As shown in FIG. 8, the step 104 of converting orbits to digital values may include the sub-steps of setting 112 a threshold value, making 114 any orbit value in a periodic orbit greater than the threshold value a 1, and making 116 any remaining orbit value a 0. Alternatively, the step 104 may include the sub-steps of tracking 118 the intersections of the trajectory with the control surfaces, measuring 120 the distance between consecutive intersections, and concatenating 122 the binary forms of the measurements. In another alternative embodiment, the step 104 may include the sub-steps of labeling 124 various sections of the chaotic system with digital labels or coordinates, and concatenating 126 the digital labels or coordinates visited during periodic orbit. It should be noted that any suitable approach for converting orbits to digital values may be employed, and the variations discussed above are provided by way of illustration only, and should not be construed as limiting in any way.

As shown in FIG. 8, the step 106 of matching the periodic orbits to the original digital data values may include the sub-steps of organizing 128 the converted digital data values and identifying 130 whether there are any outlying values in the original digital data. Illustratively, an outlying digital data value exists when a string of bits in the original data exists, without a single matching digital data value string from the conversion step 104. If this is the case, then at least two separate digital data values of the periodic orbits of step 104 are combined at step 132, to construct a matching data value for the outlying digital data value. One method for accomplishing this combination is to add, at step 132, multiple converted numeric values of the periodic orbits to construct a matching digital data value for the outlying digital data value. Another method for accomplishing the combination is to concatenate, at step 134, multiple converted numeric values of the periodic orbits to construct a matching digital value for the outlying digital data value.

As also shown in FIG. 8, subsequent to step 110, the reduced control bit strings identified in step 108, optionally, are stored 136 to memory. As shown in step 138, optionally, the reduced control bit strings of step 110 are transmitted to a receiver. If the control bit strings are transmitted at step 138, in lieu of, or in addition to, storing in step 136, they are decompressed at the receiver. More particularly, at step 140, the control bit strings are opened. Then at step 142, the periodic orbits corresponding to the control bit strings are regenerated. Next, at step 144, the numeric values of the periodic orbits are converted to digital data values. One benefit of the decompression process is that, unlike most decompression tools, access to a compression dictionary is not required.

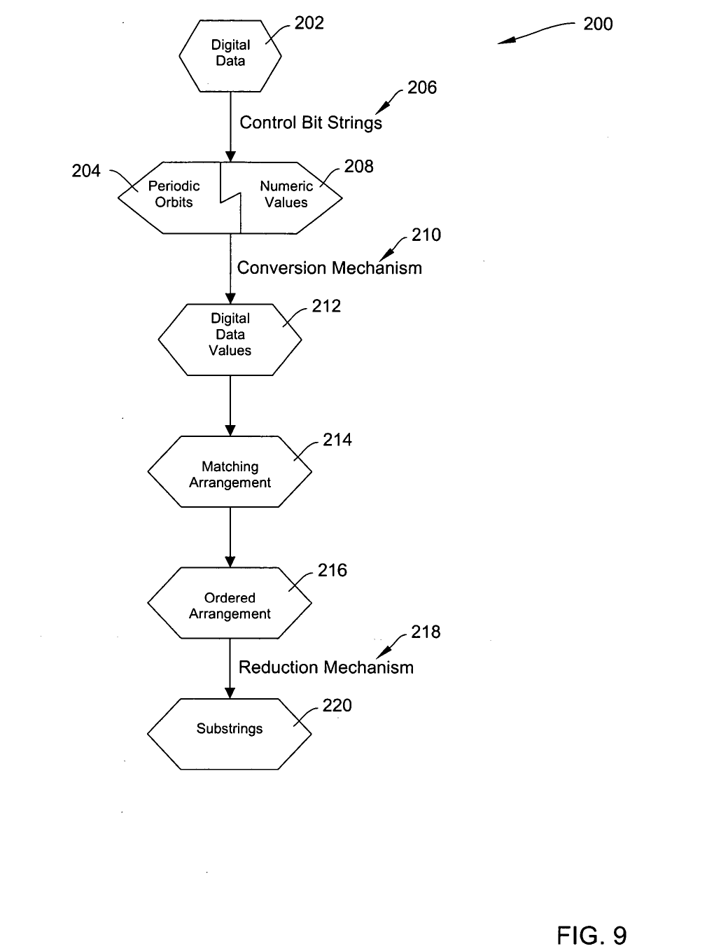

FIG. 9 is a conceptual block diagram of a system 200 for compressing digital data 202 according to the illustrative method of FIGS. 7 and 8. The data 202 includes strings of digital values, which can be broken down in to a binary series of 1's and 0's. The system 200 includes a plurality of periodic orbits 204 corresponding to a plurality of control bit strings 206. The periodic orbits 202 have a series of numeric values 208. A conversion mechanism 210 uses the numeric values 208 of the plurality of periodic orbits 204 to generate a set of digital data values 212. The system 200 also includes a matching arrangement 214 for organizing the generated digital data values 212 to identically match them to the original digital data values 202. The system 200 also includes an ordered arrangement 216 of the control bit strings 206 corresponding to the matching arrangement 214 of the generated digital data values 212. The system 200 also provides a reduction mechanism 218 for reducing each control bit string 206 to a smaller substring 220. The smaller substring 220 is then used in place of the control bit string 206.

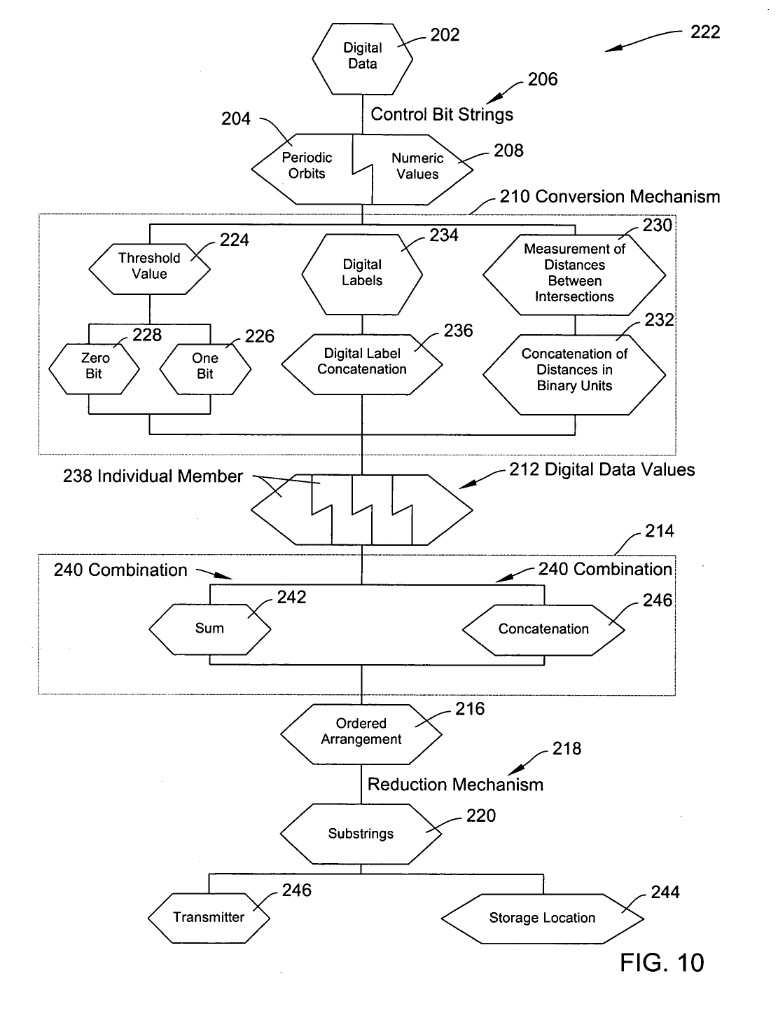

FIG. 10 provides a more detailed block diagram 222 for the system 200 depicted in FIG. 9, according to an illustrative embodiment of the invention. As shown in FIG. 10, the conversion mechanism 210 for converting orbits to digital values may include sub-elements for setting 224 a threshold value, and for making any orbit value in a periodic orbit greater than the threshold value a 1 (226), and making any remaining orbit value a 0 (228). Alternatively, the conversion mechanism 210 may include sub-elements for tracking the intersections of the trajectory with the control surfaces, measuring the distance between consecutive intersections 230, and concatenating the binary forms of the measurements 232. In an alternative embodiment, the mechanism 210 may include sub-elements for labeling different sections of the chaotic system with digital labels or coordinates 234, and for concatenating 236 the digital labels or coordinates 234 visited along a periodic orbit. It should be noted that any suitable mechanism for converting orbits to digital values may be employed, and the variations discussed above are provided by way of illustration, and should not be construed as limiting in any way.

As shown in FIG. 10, the matching arrangement 214 for matching the periodic orbits 204 to the original digital data values 202 may include elements for organizing the converted digital data values 212 and identifying whether there are any outlying values in the original digital data 202. Illustratively, an outlying digital data value exists when a string of bits in the original data exists, without a single matching digital data value string 238 from the conversion mechanism 210. In this circumstance, the matching arrangement 214 of generated digital values 212 includes a generated digital data value combination 240 formed from a plurality of individual members 238 of the set of digital data values 212. This combination 240 may be constructed by a sum 242 of multiple individual members 238. Alternatively, the combination 240 may be constructed by a concatenation 246 of the plurality of individual members 238. In one embodiment of the system 200, the original digital data values 202 and the generated digital data values 212 are up to n-bits long.

As also shown in FIG. 10, the reduced control bit strings 220 of FIG. 9, optionally, are stored to memory 244. The reduced control bit strings, optionally, may also, or alternatively, be transmitted 246 to a receiver.

Although FIG. 10 graphically depicts the system as functional block elements, it will be apparent to one of ordinary skill in the art that these elements can be realized as computer programs or portions of computer programs capable of executing on a data processor platform to thereby configure the data processor as a system according to the invention. In that embodiment, the DRM systems can be implemented as a C language computer program, or a computer program written in any high-level language, for example, C++, Fortran, Java or Basic.

Additionally, in an embodiment where microcontrollers or digital signal processing (DSP) circuitry is employed, the DRM system can be realized as a computer program written in microcode, or written in a high-level language and compiled down to microcode, that can be executed on the platform employed. The development of such program is known in the art, and such techniques are set forth in, for example, “Digital Signal Processing Applications with the TMS320 Family, Volumes I, II, and III,” Texas Instruments (1990). Additionally, general techniques for high level programming are known, and set forth in, for example, Stephen G. Kochan, Programming in C, Hayden Publishing (1983). It is noted that DSPs are particularly suited for implementing signal processing functions, including preprocessing functions such as image enhancement through adjustments in contrast, edge definition, brightness, and other techniques known in the art. Furthermore, developing code for the DSP and microcontroller systems follows from principles well known in the art.

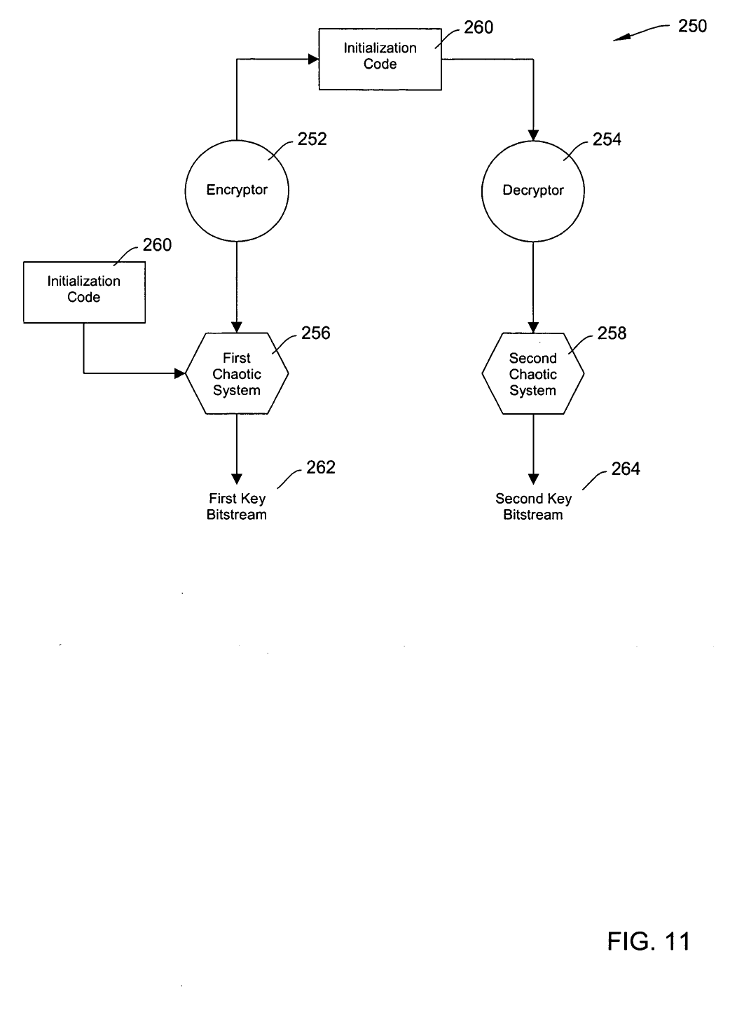

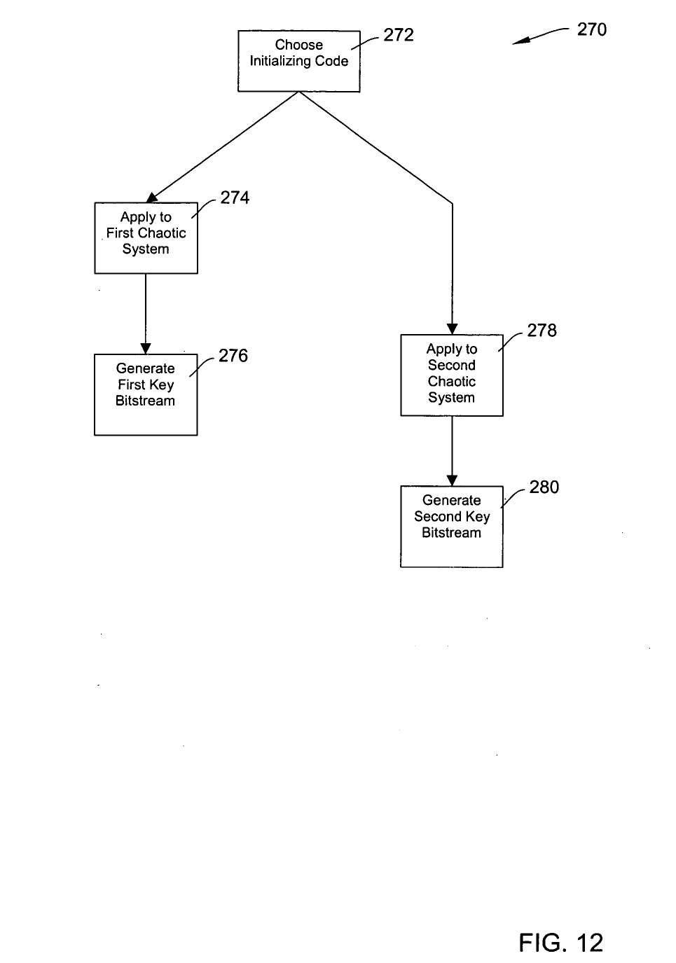

As described above with respect to FIGS. 1A-2C, the illustrative embodiment of the invention can employ various types of unique identifiers in the generation of an encryption/decryption key. Additionally, as described above with respect to FIGS. 3-10, the unique identifier can particularly be employed with chaotic systems as an initialization code to generate a chaotic encryption key. According to another feature of the invention, and as described below with respect to FIGS. 11 and 12, the chaotic encryption key can be remotely generated at a receiving client device to enable the receiving client device to decrypt received digital content, thereby eliminating the need to transmit the digital encryption key to the client device.

More particularly, FIG. 11 shows a remote digital key generating system 250 according to an illustrative embodiment of the invention. As shown, the system 250 includes an encryptor 252 and a decryptor 254. It also includes two identical chaotic systems, some embodiments of which are described above: the first chaotic system 256 and the second chaotic system 258. In operation, the encryptor 252 applies an initialization code 260, to the first chaotic system 256. In response to the initialization code 260, the first chaotic system 256 generates an unpredictable first key bitstream 262 of a desired length. The first key bitstream 262 can be used as a digital key to encrypt digital content according to any of a number of encryption algorithms known to those skilled in the art. The encryptor 252 also conveys the initialization code 260 to the decryptor 254; the decryptor 254 in turn applies the initialization code 260 to the second chaotic system 258. In response, the second chaotic system 258 generates a second key bitstream 264, which is identical to the first key bitstream 262. The second key bitstream 264 can be used as a digital key to decrypt digital content encrypted with the first key bitstream 262.

FIG. 12 is a flow diagram 270 depicting an illustrative remote digital key generation process 250 of the type that may be implemented on the system 250 of FIG. 11. In the first step 272, an initialization code, which may be a unique identifier, is chosen. In step 274, the initialization code is applied to a first chaotic system to cause it to generate 276 a first key bitstream of any desired length. The first key bitstream can be used as a digital key to encrypt digital content according to any of a number of encryption algorithms generally known in the art. In step 278, which may occur before, at the same time, or after step 274, the initialization code is also applied to a second chaotic system to cause it to generate 280 a second bitstream, which is identical to the first key bitstream generated at step 276, and can be used to decrypt any digital content encrypted with the first key bitstream.

There are many different key-based encryption algorithms known to those skilled in the art. They generally involve the transmission of a key to the decrypting party or, as in the illustrative embodiment of the invention, the transmission of a signal to the decrypting party allowing that party to generate the key. For example, public key encryption uses a public key-private key pair. The public key is used to encrypt a message, and the private key must be transmitted to, or generated remotely by, the decrypting party for decryption. In the case of the so-called knapsack algorithm, the decrypting party must receive, or generate, an increasing sequence of numbers as a key for decryption. The invention can be used to generate remotely a digital key for use in any key-based encryption algorithm. In addition, a key can be generated by combining a bitstream produced by the invention, and an unique encrypting identifier. The bitstream can be combined to produce a key, through a modulo addition to the binary numbers or any other operation on the bits.

### Digital Rights Management of Audio Content

In one illustrative embodiment, the DRM methods and systems of the invention can be used for managing the rights of audio content. FIG. 13 is a conceptual diagram depicting a system 300 particularly adapted for chaotic compression and decompression of audio content according to an illustrative embodiment of the invention.

The system 300 includes a compression controller 302 for applying selected digital initialization codes to a selected chaotic system 304. Each initialization code produces a basic waveform that is stored in a library 306 with its corresponding initialization code. A subset of audio data, for example, a portion of an audio signal or an audio file, to be compressed 308 is analyzed in a waveform comparator 310, which then selects the basic waveforms in the library 306 most closely related to the subset of the audio data to be compressed 308 and their corresponding initialization codes. A waveform weighter 312 then generates a weighted sum of the selected basic waveforms to approximate the subset of audio data 308 and the weighting factors necessary to produce the weighted sum. The basic waveforms are then discarded, and the weighting factors and the corresponding initialization codes form a compressed audio representation, for example, a compressed audio signal or a compressed audio file, which can be stored in a storage device 314.

For decompression and playback, the compressed audio data is transmitted to a remote decompression controller 316, which strips out the stored initialization codes and applies them to the chaotic system 318 used in compression; the chaotic system 318 is identical to the chaotic system 304. Each initialization code produces a basic waveform that is sent to a waveform combiner 320. The basic waveforms are combined in the waveform combiner 320, according to the weighting factors, to reproduce the original subset of audio data for playback through any suitable device 322.

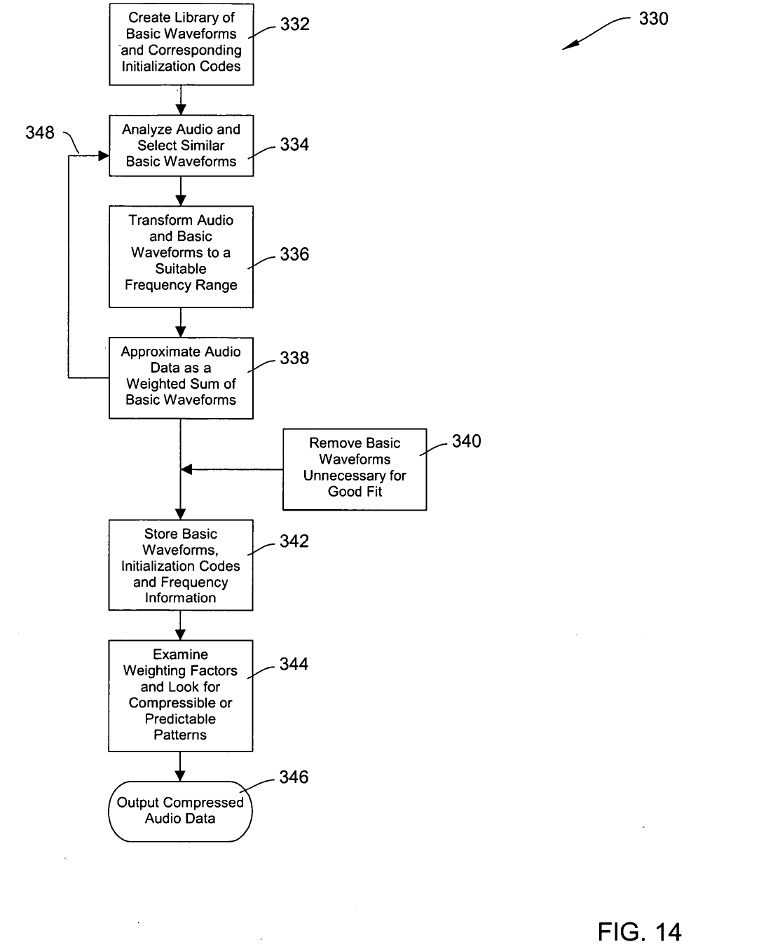

FIG. 14 provides a flow diagram of a process 330 of the type that may be implemented on the audio compression/decompression system 300 of FIG. 13. The process 330 begins with step 332 in which a library 306 of basic waveforms and corresponding initialization codes is compiled as described in detail below. Illustratively, the library 306 contains all of the basic waveforms and corresponding initialization codes for a particular chaotic system. In addition, relevant reference information about the waveforms can be stored efficiently in a catalog file. The information in the library 306 can be static for a given embodiment. In most applications, the catalog file contains all relevant information and can be retained while the waveforms can be discarded to save storage space.

The illustrative embodiment uses digital initialization codes to drive a chaotic system onto one or more periodic orbits and to stabilize the otherwise unstable orbits. Each periodic orbit then produces a basic waveform corresponding to a traditional musical sound, since it includes the harmonic tones that give different instruments their distinctive sound qualities. Consequently, instead of producing a single pitch (i.e., a sine wave) at the root frequency, as might be produced by a tone generator, the periodic orbit contains tones at multiples of the root frequency. In one embodiment of the invention wherein the double-scroll oscillator of FIG. 3 is the chaotic system employed, each periodic orbit corresponds to a basic waveform with a natural harmonic structure that is related to the number of loops traversed along one lobe before moving off to the next lobe. Consequently, distinct periodic orbits produce distinct basic waveforms, which in turn correspond to distinct musical instruments. Thus, a group of initializing codes may produce basic waveforms having the tonal qualities of a harpsichord; another group may produce basic waveforms that sound more like an electric guitar; another group may produce basic waveforms that sound like an electric piano, and so on.

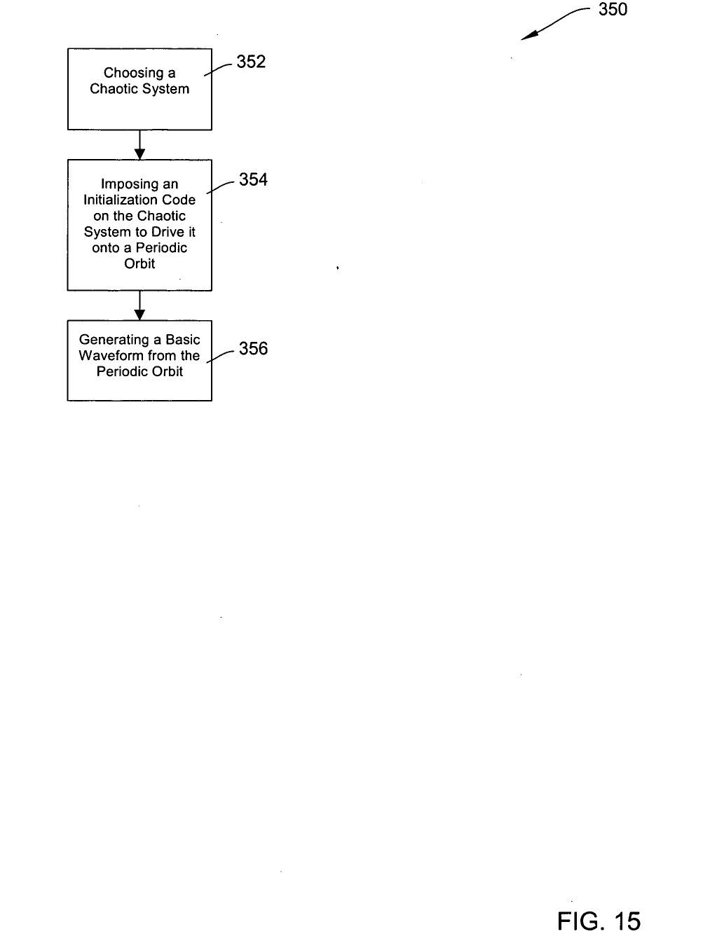

FIG. 15 is a flow chart showing in greater detail a process 350 for the creation of the library 306 of basic waveforms and corresponding initialization codes for one embodiment. The first step 352 includes choosing a chaotic system to be driven onto the periodic orbits corresponding to the basic waveforms. In one embodiment, the chaotic system is the double-scroll oscillator discussed in detail above, with respect to FIGS. 3-5.

This process is discussed in detail above with respect to FIGS. 3-6. The next step 354 in creating the library 306 basic waveforms and corresponding initialization codes and basic waveforms includes the application of an initialization code on the chaotic system. The initialization code drives the chaotic system onto a periodic orbit and stabilizes the otherwise unstable periodic orbit. More specifically, the chaotic system is driven onto a periodic orbit by applying to it a repeating code.

As shown in FIG. 15, the next step 356 in creating the library 306 includes generating a basic waveform, i.e., a one-dimensional periodic waveform, for each periodic orbit, by taking a function of the x-, y-, or z-component (or a combination of them) of the periodic orbit over time. This process is also described in detail with respect to FIGS. 3-6.

Returning to the flow chart in FIG. 14, at step 334, a subset of the audio data to be compressed is chosen and analyzed and certain basic waveforms are selected from the library 306 of basic waveforms. The subset of the audio data is analyzed and compared to the basic waveforms in the library 306. The comparison may be implemented by extracting key reference information from the subset of the audio data and correlating the reference information with the information in the catalog file. Those basic waveforms that are most similar, based on selected criteria, to the subset of the audio data are then selected and used to build an approximation of the subset of the audio data.

There are many approaches that can be employed to compare the basic waveforms and the subset of the audio data, including a comparison of numbers of zero crossings; number and relative power of harmonics in the frequency spectrum; a projection onto each basic waveform; and geometric comparisons in phase space. The technique chosen is dependent upon the specific application under consideration. However, in one embodiment, it has been effective to encapsulate the basic waveform information in a vector describing the (normalized) magnitudes of the strongest harmonics.

A comparator matrix is created to contain information about the spectral peaks of each basic waveform in the library 306. Then, for a subset of the audio data; a comparison is made between the spectrum of the subset of the audio data, and the spectrum of the basic waveforms. In the encapsulated form, the basic waveform that is the closest match can be found merely by taking inner products between a vector representative of the subset of the audio data and the vectors representative of the basic waveforms, for example, the vectors of the spectral peaks associated with the basic waveforms. The best-match basic waveform is selected as the first basis function, along with other close matches and basic waveforms that closely matched the parts of the spectrum that were not fit by the first basis function.

In various applications, there may be a variety of approaches to choosing the basic waveforms for retention as basis functions, but the general approach is to project the subset of the audio data onto the library 306 of basic waveforms. Finally, in some applications it is unnecessary or undesirable to keep a library 306 of basic waveforms; in these cases the basic waveforms are recreated as needed by applying appropriate initialization codes to the chaotic system to cause the chaotic system to assume the periodic orbits associated with the basic waveforms.

After the appropriate basic waveforms have been selected, one can begin to approximate the subset of the audio data. In step 336 of FIG. 14, all of the selected basic waveforms and the subset of the audio data are transformed to a proper frequency range, either the audio data range or a fixed reference range, in which a comparison can be made. For example, they can be resampled so that they are in a specified frequency range. This can be accomplished through standard resampling techniques. Typically, the resampling is performed to obtain better resolution of the signals (i.e., upsampling), so no information is lost in the process.

Once the subset of the audio data and all the waveforms are in the proper frequency range, an approximation, in step 338, is possible. A necessary component is to align the basic waveforms properly with the waveforms of the subset of the audio data (e.g., adjust the phase), as well as to determine the proper amplification factor or weighting factor (e.g., adjust the amplitude). There are a number of ways this can be done, but a common approach involves a weighted sum of the chosen basic waveforms. The weighting factors are found by minimizing some error criterion or cost function, and typically involve something equivalent or analogous to a least-squares fit to the subset of the audio data.

An approach used in one embodiment is to take all of the basic waveforms and split them into a pair of complex conjugate waveforms. This can be accomplished by taking a basic waveform, f₁, calculating the fast Fourier transform (FFT) of the basic waveform, call it F₁, and splitting the transform in the frequency domain into positive and negative frequency components F₁ₚₒₛ, F_{1neg}. The positive and negative frequency components are then transformed separately back to the time domain by using the inverse Fourier transform, resulting in a pair of time-domain complex conjugate waveforms, f₁ₚₒₛ and f_{1neg}, where f₁ₚₒₛ=(f_{1neg})*.

One important benefit of the splitting and inverse Fourier transforming of the waveforms to obtain complex-valued time-domain waveforms is that when the complex conjugate waveforms are added together with any complex conjugate pair of weighting factors, the result is a real waveform in the time domain; that is, if α and α* are the coefficients, then αf₁ₚₒₛ+αf_{1neg} is a real function, and if the coefficients are identically 1, the original function f₁ is reproduced (adjusted to have zero mean).

Further, by choosing α and α* properly, the phase of the waveform can be automatically adjusted. In practice, all of the phase and amplitude adjustments can be achieved at once for all of the basic waveforms, simply by doing a least squares fit to the subset of audio data, for example, a segment of a music signal, using the complex-valued time-domain pairs of complex conjugate waveforms derived from the basic waveforms. The weighting functions from the least squares fit are multiplied by the associated waveforms and summed to form the approximation to the subset of the audio data, for example, the segment of a music or speech signal. This approximation can then be tested to determine if the fit is sufficiently good in step 338, and if further improvement is necessary the process can be iterated, as shown at 348.

Alternative embodiments of the fitting process exist. The overall goal of the fitting is to produce a sufficiently accurate representation of the frequency spectrum of the original content. One such approach utilizes the real and imaginary parts of the frequency spectrum of the content. When the real and imaginary parts are approximated with sufficient accuracy, a suitable reconstruction of the original content is possible. In another embodiment, the magnitude and phase components of the spectrum are used. When the magnitude and phase parts of the spectrum are approximated with sufficient accuracy, a suitable reconstruction of the original content is achieved. In these approaches, the spectral representations of the original content are substantially equivalent, so the approximation of the original content can be suitable. Once it is calculated, the approximation can then be tested to determine if the fit is sufficiently good in step 338, and, if further improvement is desired or necessary, the process can be iterated, as shown at 348.

The next stage of the compression, step 340, involves examining the approximation and determining if some of the basic waveforms used are unnecessary for achieving a good fit. Unnecessary basic waveforms can be eliminated to improve the compression.

After removing the unnecessary basic waveforms, the initialization codes for the remaining basic waveforms, the weighting factors, and the frequency information can be stored in step 342, and then examined in step 344 to determine trends over sections of data. These trends can be predictable, and in test cases have been shown to be well-approximated by piecewise linear functions. When these trends are identified, the weighting factors for many consecutive sections of audio file can be represented by a simple function. This means that the weighting factors do not need to be stored for each section of audio file. This leads to improvements in the compression.

Further improvements can be made by making geometric transformations on the space that contains the chaotic attractor, such as through conformal mappings, linear transformations, companding techniques or nonlinear transformations, so that the basic waveforms are altered slightly into a form more suitable for efficient compression. Finally at step 346, the compressed audio data is produced. The compressed audio file can be stored and transmitted using all storage and transmission means available for digital files.

Another embodiment of the invention is now described in more detail, but there are many variations that produce equivalent results. FIG. 16 is a graph of a segment 360 of music, sampled at the standard CD rate of 44, 100 Hz with 16 bits of amplitude information stored for each sample. Time is depicted along the x-axis 362, and amplitude is depicted along the y-axis 364. In this example, a segment of a music signal of length 1024 samples has been chosen, and the entire section is to be compressed. In general, the segment length is an adjustable parameter, and in some implementations it would even dynamically vary during the compression of a single audio file, often according to an optimality criterion to improve the quality of the compression.

The first step in the process is to analyze the section 360 of music to determine the harmonics present in the section of music. This is done by calculating the FFT and then taking the magnitude of the complex Fourier coefficients. The spectrum of coefficients is then searched for peaks, and the peaks are further organized into harmonic groups.

At the first iteration, the harmonic group associated with the maximum signal power is extracted. This is done by determining the frequency of the maximum spectral peak, and then extracting any peaks that are integer multiples of the maximum spectral peak. These peaks are then stored in a vector, vₚₑₐₖₛ, to give the first harmonic grouping. In practice, further refinement of the harmonic grouping is necessary, as the fundamental, or root, frequency of a musical note is often not the maximum peak. Rather, the root frequency would be an integer subharmonic of the maximum frequency, so if Fₘₐₓ is the frequency with the maximum power, harmonic groups of peaks based on a root frequency of Fₘₐₓ/2, then Fₘₐₓ/3, etc. would be extracted, and then the first harmonic group would be the one that captures the greatest power in the peaks.

The vector containing the first harmonic grouping is taken to be of length 64 in this embodiment, and, although other implementations may set different lengths, it is necessary to allow for a large number of harmonics in order to capture the complexity of the basic waveforms.

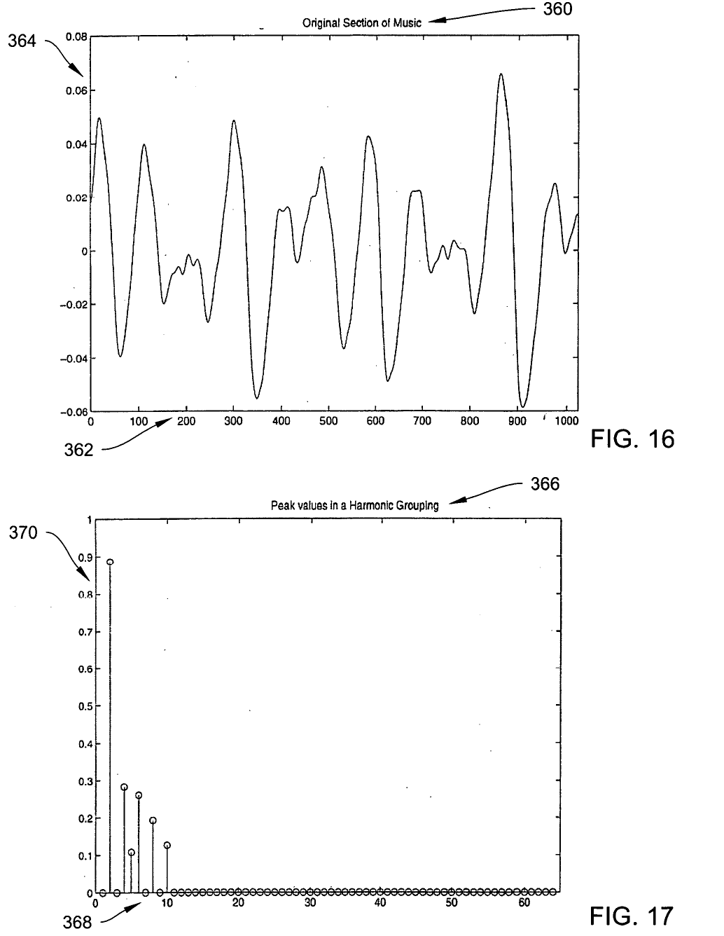

FIG. 17 is a graph of the peak values (vₚₑₐₖ) in a harmonic grouping. In the graph 366, frequency (and in particular the number of harmonics) is represented along the x-axis 368 and spectral magnitude along the y-axis 370. One goal of the next stage of the compression is to find basic waveforms that have similar harmonic structure to the section of music in question.

The second step in the process is to find basic waveforms in the library 306 of basic waveforms that exhibit similar spectral characteristics. This process can be simplified by establishing the library 306 ahead of time, with each basic waveform in the library 306 having previously been analyzed to determine its harmonic structure. Consequently, for each waveform in the library 306, a vector of harmonic peaks is extracted (call these vectors pᵢ, where i varies over all waveforms), and assume that 64 peaks have again been taken. These vectors are first normalized to have unit length, and are then placed in a matrix M having 64 columns and as many rows as there are waveforms (up to around 26,000 in one embodiment). To keep track of which waveform is associated with which row in M, an index table is set up containing the control code associated with each row in M. Then, to find the closest match to the music vector, vₚₑₐₖₛ, the matrix-vector product x_{projection}=Mvₚₑₐₖₛ can be calculated to find the maximum value in x_{projection}. The row that gives the maximum value corresponds to the basic waveform that matches the segment of the music signal most closely.

The corresponding initialization code can be extracted from the index table, and the desired basic waveform generated. Alternatively, if the basic waveforms have been stored digitally, they can simply be loaded from the library 306 of basic waveforms. In many instances, it is worthwhile to choose more than one close match to the segment of data, since a weighted sum of several basic waveforms is necessary to produce a suitable match; these can be taken by selecting the largest values in x_{projection}, and taking the associated basic waveforms indicated in the index table.

FIG. 18 depicts one full period 372 of the best match basic waveforms for the section of music depicted in FIG. 16. In FIG. 18, time is represented along the x-axis 374 as 1024 samples, and amplitude is plotted along the y-axis 376. Next, the waveforms are adjusted so that their periods and phases match that of the music file.

The third step in the process is to adjust the period and phase of the basic waveforms. As the basic waveforms are periodic, the adjustment process can be completed without introducing any errors into the basic waveforms. This can be done in the frequency domain, so, for example, the transformations may be applied to the FFT of the basic waveforms, using standard techniques known in signal processing. The basic waveforms are adjusted so that the root frequencies of the basic waveforms match the root frequencies of the segment of the audio data, for example, the music signal. To do this, the FFT of the basic waveform is padded with zeros to a length that corresponds to the length of the FFT of the segment of music. The complex amplitude of the root frequency of the basic waveform is then shifted up to the root frequency of the segment of music, and the remaining harmonics of the root frequency of the basic waveform are shifted up to corresponding multiples of the root frequency of the segment of music (the vacated positions are filled with zeros).

After the shifting, if the inverse FFT is calculated, the basic waveforms will all have the same root frequency as the segment of music; however, the phase of the basic waveforms may not match the phase of the segment of music. Therefore, before calculating the inverse FFT, the phase of the chaotic waveforms is adjusted so that the phase of the basic waveform matches the phase of the maximum peak in the section of music.

The phase adjustment is achieved by multiplying the complex Fourier amplitudes in the FFT by an appropriate phase factor of the form e^{iθ} where θ is chosen to produce the correct phase for the peak corresponding to the maximum peak in the section of music, and the phases of the other spectral peaks are adjusted to produce an overall phase shift of the basic waveform. Note that by multiplying by a phase factor, the overall spectrum of the signal is unchanged. (Different embodiments of the technology use slightly different approaches to the phase adjustment, for example, one can adjust the phase through filtering, or the phase adjustment can be calculated by an optimization principle designed to minimize the difference between the music and the basic waveform, or by calculating the cross-correlation between the basic waveforms and the section of music. All approaches give approximately equivalent results.) The waveforms 378 resulting from the phase and frequency adjustments being made to the basic waveforms are depicted in FIG. 19, where 1024 samples of time appear represented along the x-axis 380 and amplitude is plotted along the y-axis 382.

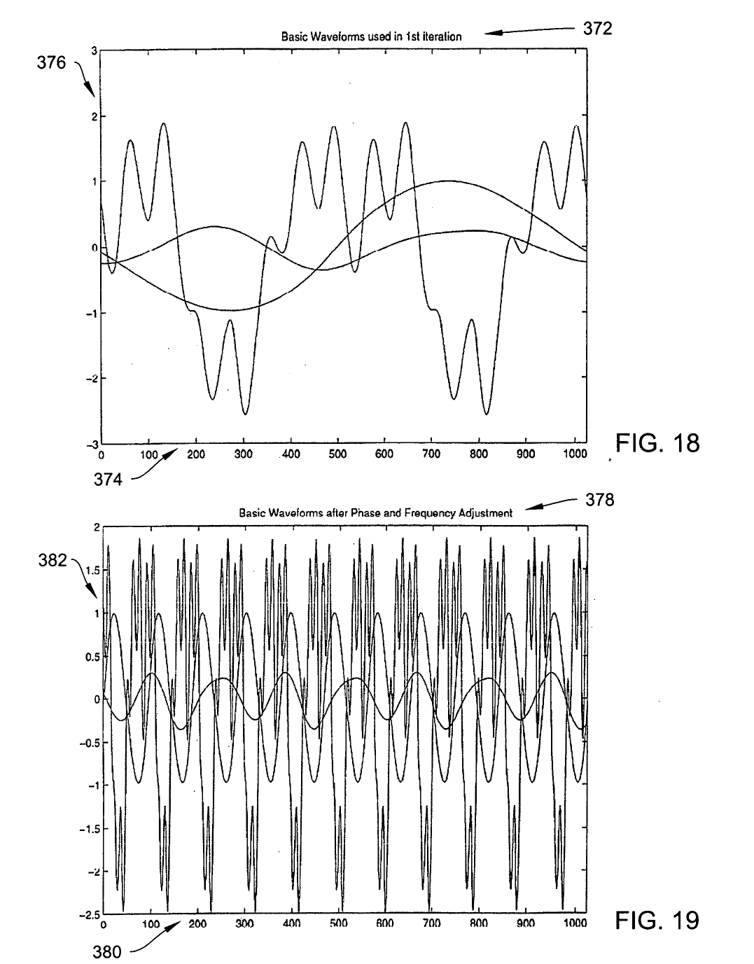

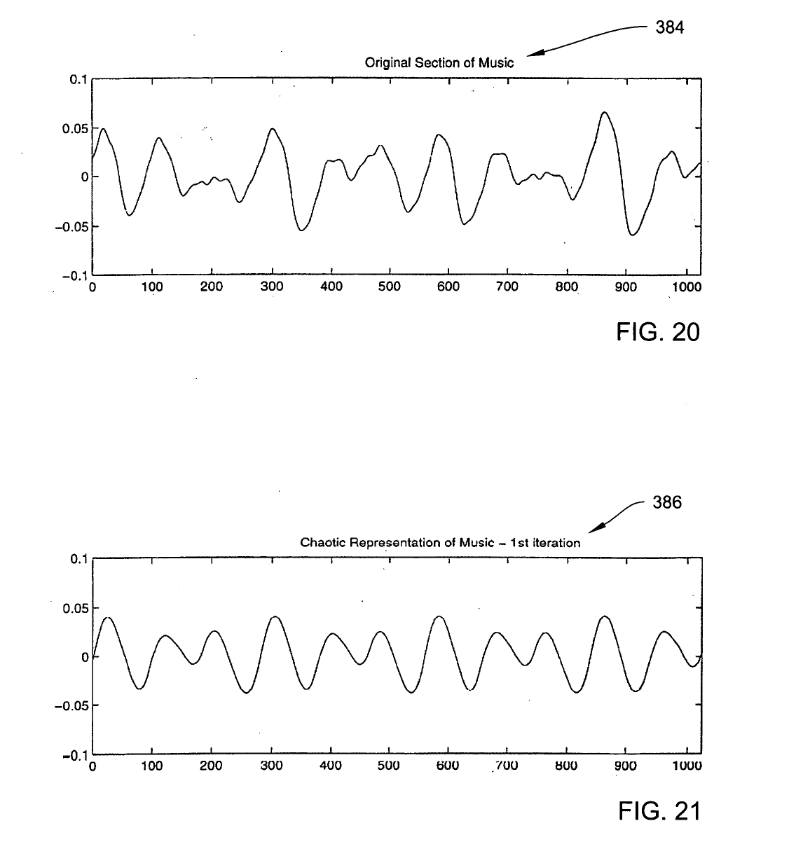

The fourth step in the process is to compute the weighting factors for the sum of basic waveforms that produces the closest match to the section of music. In one embodiment, this calculation is performed using a least-squares criterion to minimize the residual error between the segment of music data and the fitted (e.g., a weighted combination of) basic waveforms. The original section 384 of music appears in FIG. 20 and a first approximation 386 reconstruction according to the illustrative embodiment appears in FIG. 21, where 1024 samples of time are plotted along the x-axis and amplitude is plotted along the y-axis. The differences are small; therefore, the chaotic decompression-based version of the music sounds substantially like the original.

In the event that the first group of basic waveforms does not produce a close enough match to the segment of music data, the process is iterated until the desired representation is reached. As can be seen, the compressed chaotic version 386 requires only information about the initialization codes, weighting factors, and frequencies for a few basic waveforms, rather than 16 bit amplitude information for each of the data points in the segment of music data.

The approach of the invention can also be used to create compressed speech data, for example, speech signals or files. In one embodiment, speech samples from a standard database (e.g., the TIMIT database) are projected onto a family of waveforms built up from just five fiducial basic waveforms. The comparison of the speech and the waveforms is performed at a fixed reference frequency, W, and the processing is performed in a comparison block corresponding to N periods at the frequency W. The five waveforms are expanded or compressed so that in the comparison block, each fiducial waveform is resampled to produce a family of waveforms containing waveforms with a single period, two periods, three periods, four periods, five periods and six periods, respectively, in the comparison block. A segment of the speech data is selected and its power spectrum is computed to find the dominant frequency with the maximum power. The segment of speech data is then resampled to shift the dominant frequency to the reference frequency W, and a number of points corresponding to the length of the comparison block is taken. Note that the resampling is performed so that the data is smoothly interpolated, so no information is lost. The segment of speech data is then approximated using a weighted sum of the waveforms. Each basic waveform is mapped to the corresponding initialization code and stored along with the weighting factors and frequency information in the compressed file. Processing of other segments of the speech data follows in a similar fashion. The compressed file can be decompressed to regenerate the (approximation to the) original segment of the speech data, producing intelligible speech.

In an alternative embodiment, the basic waveforms are fixed, and no adjustments are made to match the frequencies present in the speech. To process a segment of speech data of block length L, a family of basic waveforms is selected and each basic waveform is recomputed to produce over the block length L, a single period, two full periods, three full periods, . . . , up to six full periods. Upper limits other than six may be used in alternative embodiments. Each basic waveform is then “twinned” to form an analog of a sine-cosine pair. This is achieved by taking each basic waveform and calculating the autocorrelation function. The first zero of the autocorrelation function defines a time lag, such that the basic waveform and a time-lag, i.e., time-shifted, copy of the basic waveform are independent in an information-theoretic sense. This family of basic waveforms can then be used to represent the segment of speech, so that a compressed speech representation, for example, a compressed signal or file, is produced. The decompressed version of the compressed speech data produces intelligible speech. The high compression ratios may make practical an Internet telephony protocol that maintains fidelity, reduces latency and lost packets, and/or reduces bandwidth. Other embodiments of the fitting process for speech can be used in a similar fashion. Any accurate representation of the frequency spectrum of the original content that can be produced by the fitting process is acceptable. One such approach utilizes the real and imaginary parts of the spectrum of the content. When the real and imaginary parts are approximated with sufficient accuracy, a suitable reconstruction of the original content is achieved. According to another practice, the magnitude and phase components of the spectrum are used. When the magnitude and phase parts of the spectrum are approximated with sufficient accuracy, a suitable reconstruction of the original content is achieved. In these embodiments, the spectral representations of the original content are substantially equivalent, so the approximation of the speech is suitable.

### Digital Rights Management of Image and/or Video Content

According to another illustrative embodiment, the DRM methods and systems of the invention can be used for managing the rights of image and/or video content.

FIG. 22 is a conceptual block diagram depicting a system 400 for chaotic compression and decompression of image and/or video content, according to an illustrative embodiment of the invention. As shown, the system 400 includes digital image content 402 stored in any one of a number of common formats and an image decomposer 404 for decomposing the image content into “slices” (e.g., single scan lines on an analog screen or single rows of pixels in a digital image). The maximum length of the slice is externally imposed by the size of the image but multiple shorter slices having the maximum length may be selected.

The slice of the image is then processed by a slice data detrender 406, in which a trend line is calculated and trend line information describing the trend line is stored in storage device 408. The trend line is subtracted from the slice data, and the residual data (difference of the image slice and the trend), or detrended image slice, is retained.

A compression controller 410 applies selected digital initialization codes to a selected chaotic system 412. Each initialization code produces a basic waveform that is stored in a library 414 with its corresponding initialization code. The detrended image slice from an image slice to be compressed is analyzed in a waveform comparator 416, which then selects the basic waveforms and their corresponding initialization codes in the library 414 that are most closely related to the detrended image slice to be compressed, and transforms all the selected basic waveforms and the detrended image slice to a proper frequency range.

A waveform weighter 418 then generates a weighted sum of the selected basic waveforms to approximate the detrended image slice and the weighting factors necessary to produce the weighted sum. The basic waveforms are then discarded and the corresponding initialization codes, certain phase and frequency information, and the weighting factors, are stored in the storage device 408. The stored trend line information, initialization codes, phase and frequency information, and weighting factors are included in a compressed image data, for example, a compressed image signal or file.

For decompression and playback, the compressed image data is transmitted to a remote decompression controller 420, which strips out the stored initialization codes and applies them to a chaotic system 422; the chaotic system 422 is identical to the chaotic system 412 used in compression. Each initialization code produces a basic waveform, which is sent to a waveform combiner 424. The decompression controller 420 also sends the stored phase and frequency information and weighting factors from the compressed image data to the waveform combiner 424. The basic waveforms are transferred to the proper frequency range and combined in the waveform combiner 424 according to the weighting factors to reproduce the original detrended image slice. The detrended image slice data is then processed by a slice data retriever 426 in which the trend line is added to the detrended image slice data to produce an approximation of the original image slice data.

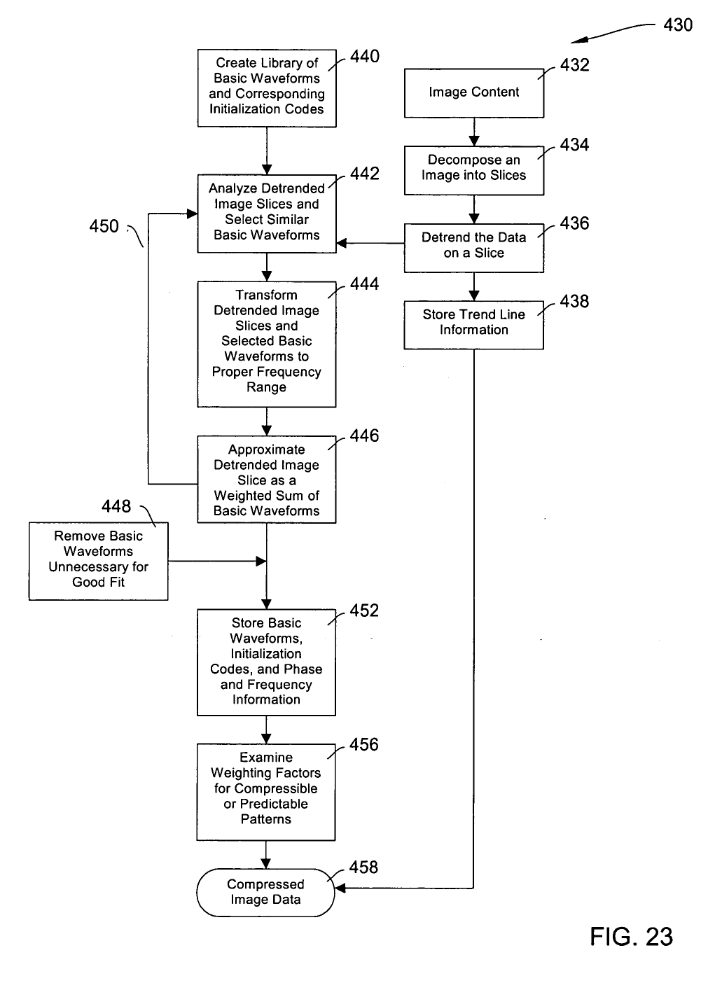

FIG. 23 is a flow chart of a process 430 for compressing and decompressing image and/or video content, according to an illustrative embodiment of the invention. The process 430 begins with the image content 432 in any one of a number of common formats, such as those discussed above with respect to FIGS. 3-6. An image from the image content 432 is then decomposed in step 434 into “slices” (e.g., a single vertical or horizontal scan line on an analog screen or a single vertical or horizontal line of pixels in a digital image). The maximum length of the slice is externally imposed by the size of the image, but multiple shorter slices having the maximum length may be used. The data on the slice is either the gray level at each position in grayscale format or the color level, at each position in any other format.

In step 436, the data on the image slice is then considered as a one-dimensional collection of ordered data points. The slice data, which is either a gray level or a color level, or any variable in a standard format, often shows a definite trend, either increasing or decreasing over an extended span. It does not necessarily appear oscillatory and does not necessarily have the short-term periodic structure of chaotic waveforms. Therefore, a trend is removed from the slice data to produce a detrended image slice. In cases where there is a discontinuity in the trend of the data across the slice, one can break the slice into a small number of shorter slices and remove the trend from each shorter slice. In one embodiment, in lieu of a trend line, a spline curve fit to the data or any other functional approximation of the large scale trends in the data may be used. In other embodiments, the data on the slice is considered to be a one-dimensional collection of ordered data points, and a best-fit least squares regression line is calculated to fit the data. This best-fit line is the trend line, and once it is subtracted from the data, the residual data, or detrended image slice, formed by subtracting the trend line from the image slice is substantially oscillatory in nature. Trend line information describing the trend line is stored at step 438 as part of the compressed image data. The detrended image slice is now suitable for compression onto chaotic waveforms.

As already mentioned, the systems and methods described herein employ digital initialization codes to drive a chaotic system onto periodic orbits and to stabilize the otherwise unstable orbits. Each periodic orbit then produces a basic waveform, and the set of basic waveforms produced by the initialization codes ranges from those that are slowly varying over their period to those exhibiting rapid variation. The wide range of variability results from the fact that the waveforms contain harmonics that number from just one or two to cases where there are more than 100 harmonics or even more. Consequently, even the rapid variation in subtle shading of an image can be reproduced by the chaotic waveforms, and sharp transitions are readily reproduced, because the chaotic waveforms have high harmonic content.

Thus, the process continues with step 440 in which a library 414 of basic waveforms and corresponding initialization codes is compiled as described in detail below. The library 414 contains all of the basic waveforms and corresponding initialization codes for a particular chaotic system. In addition, relevant reference information about the waveforms can be stored efficiently in a catalog file. The information in the library 414 can be static for a given embodiment. In most applications, the catalog file contains all relevant information and can be retained while the waveforms can be discarded, to save storage space.

At step 442, a detrended image slice to be compressed is chosen and compared to the basic waveforms in the library 414. The comparison may be implemented by extracting key reference information from the detrended image slice and correlating it with the information in the catalog file. Those basic waveforms that are most similar, based on predetermined criteria, to the detrended image slice are then selected and used to build an approximation of the detrended image slice.

As in the case of audio data, discussed above with respect to FIG. 14, there are many approaches that can be employed to compare the basic waveforms and the detrended image slice, including a comparison of numbers of zero crossings; number and relative power of harmonics in the frequency spectrum; a projection onto each basic waveform; and geometric comparisons in phase space. The technique chosen is dependent upon the specific application under consideration. As in the case of audio data, in one embodiment it has been effective to encapsulate the basic waveform information in a vector that describes the (normalized) magnitudes of the strongest harmonics, and compare the spectrum of the detrended image slice with the spectrum of the basic waveforms.

As in the case of step 336 of FIG. 14, after the appropriate basic waveforms have been selected, in step 444, all of the selected basic waveforms and the detrended image slice are transformed to a proper frequency range—either the detrended image slice range or a fixed reference range—in which a comparison can be made. As in the case of step 338 of FIG. 14, at step 446 the detrended image slice is approximated as a weighted sum of the basic waveforms.

As in step 348 of FIG. 14, in step 446, this approximation is tested to determine if the fit is sufficiently good, and if further improvement is necessary, the process an be iterated 450.

As in step 340 of FIG. 14, step 448 involves examining the approximation and determining if some of the basic waveforms used are unnecessary for achieving a good fit. Unnecessary basic waveforms are eliminated to improve the compression, and the initialization codes for the remaining basic waveforms, the weighting factors, and the phase and frequency information are stored in step 452 as part of the compressed image data, for example, in the form of a compressed image signal or file.

As in step 344 of FIG. 14, in step 456, the sequence of images is examined for whether there is some consistency to the waveforms and control codes used, or whether an overall trend can be identified between images in the sequence. If either is the case, then further compression is obtainable by storing the first image in the usual compressed format, along with information encapsulating the change in the image data sequence, and any correction bits deemed necessary. The compressed image data 458, including the relevant trend line information, initialization codes, phase and frequency information, and weighting factors, is produced. The compressed image data 458 can be stored as a file and/or transmitted as a signal using any storage and transmission means available for digital data.

One embodiment of the invention for decompression of a compressed image file involves reversing the steps taken to compress the image file. The stored initialization codes are extracted from the compressed image data and used to regenerate the basic waveforms, which are transformed to the proper frequency range and combined according to the appropriate weighting factors to reproduce the detrended image slice. The trend line information is then used to regenerate the trend line, which is added to the detrended image slice to produce an approximation of the original image slice.

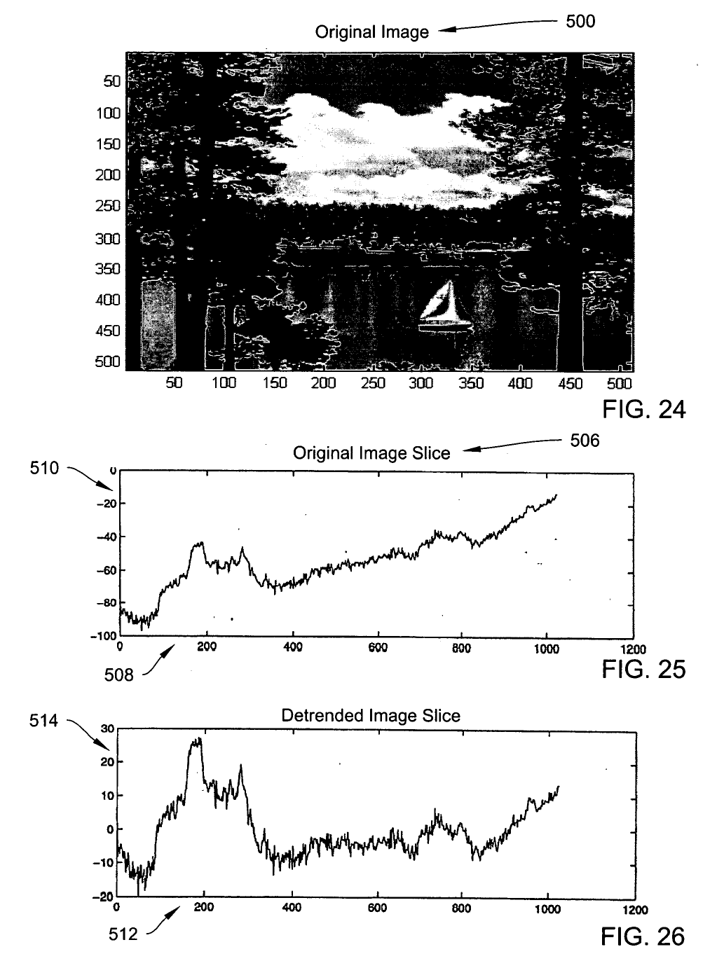

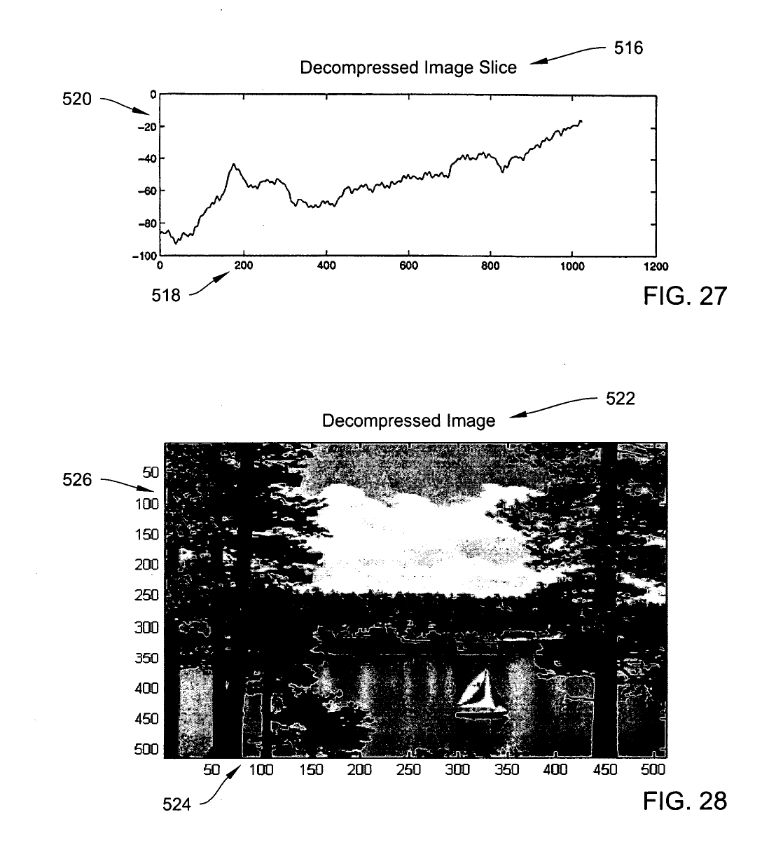

Another illustrative embodiment of the invention is now described in more detail, but it should be understood that there are many variations that produce equivalent results. FIG. 24 shows a grayscale image 500 of a natural screen, where the x-axis 502 represents horizontal image information and the y-axis 504 represents vertical image information. FIG. 25 shows data 506 from a single slice of an image, where the x-axis 508 corresponds to the pixel number and the y-axis represents the grayscale level 510. FIG. 26 shows the slice after detrending, where the pixel number is plotted along the x-axis 512 and the grayscale level is plotted along the y-axis 514. FIG. 27 shows the approximation 516 of the slice using the chaotic waveforms, where, again, the pixel number is plotted along the x-axis 518 and the detrended grayscale level is plotted along the y-axis 520. Essentially, FIG. 27 shows the chaotic-based decompressed version of the original slice.

When this process is performed on the image 500 of FIG. 24, and all the slices have been represented in the chaotic waveforms and the trend lines have been added back, the image 500 is reconstructed as the image 522 in FIG. 28, where horizontal image information is plotted along the x-axis 524 and vertical image information is plotted along the y-axis 526. Although the images are shown in gray scale, the process is equally applicable to images having color components. In general, the detrended image slice length is an adjustable parameter, and in some implementations it would even vary during the compression of data belonging to a single image.

The first step in the process is to analyze the detrended image slice to determine the frequency content of the detrended image slice. As described above with respect to FIG. 16, this can be done by calculating the FFT of the slice and then taking the magnitude of the complex Fourier coefficients. As also described with respect to FIG. 16, the spectrum of coefficients is then searched for peaks, and the peaks are further organized into harmonic groups. The second step, as described above with respect to FIG. 17, is to find basic waveforms that have similar harmonic structure to the detrended image slice in question.

As described above with respect to FIG. 18, in the third step in the process, the period and phase of the basic waveforms are adjusted. Since the basic waveforms are periodic, the adjustment process can be completed without introducing any errors into the basic waveforms. As in the case of audio content, this can be done entirely in the frequency domain.

Various embodiments may approximate the real and imaginary parts of the spectrum of the original content, or the magnitude and phase representations of the original content, to develop a suitable fit to the original. All approaches produce suitable results.

The fourth step in the process is to compute the weighting factors for the sum of basic waveforms that produces the closest match to the detrended image slice. As explained above with respect to FIG. 19 and audio data, this calculation can be done using a least-squares criterion to minimize the residual error between the detrended image slice and the fitted (e.g., weighted sum of) basic waveforms. In the event that the first group of basic waveforms does not produce a close enough match to the detrended image slice, the process is iterated until the desired representation is reached. The compression results from the fact that the compressed chaotic version requires only information about the initialization codes, weighting factors, phase and frequency and trend lines for a few basic waveforms, rather than 8-bit or 16-bit amplitude information for each of the data points in the detrended image slice.

### Additional Illustrative Applications

As discussed above, the DRM systems and methods described herein have wide applicability and may be realized- and applied through a number of embodiments and practices. For example, the receiver/client systems can include any suitable computer system such as a PC workstation, a handheld computing device, a wireless communication device, or any other such device, equipped with a processor device capable of accessing a server and interacting with the server to exchange information with the server.

Thus, in one embodiment, the system includes a web client, or web client plug-in for the Netscape web browser, the Microsoft Internet Explorer web browser, the Lynx web browser, or any other web browser, including a proprietary web browser, that allows the user to exchange data with a web server, an ftp server, a streaming media server, or some other type of server. Additionally, in certain optional embodiments the systems and methods described herein may be used to provide secure data storage systems to interact with media, like a SD card, a MMC card, or a CD-ROM. For those embodiments where additional security is desirable, optionally, the client and the server can employ a security system to protect the transmission channel, such as any of the conventional security systems that have been developed to provide to the remote user a secured channel for transmitting data over the Internet. One such system is the Netscape secured socket layer (SSL) security mechanism that provides to a remote user a trusted path between a conventional web browser program and a web server. Other security systems can be employed, such as those described in Bruce Schneier, Applied Cryptography (Addison-Wesley 1996).

Moreover, the systems described herein can include proprietary hardware devices, such as radios, MP3 players, and CD players, that include the DRM technology described above. But the DRM systems can also be realized as commercially available computer equipment that has been programmed to carry out the processes described above. For example, the transmitter may include or have access to a server supported by a commercially available server platform, such as a Sun Sparc™ system running a version of the Unix operating system and running a server capable of connecting with, or exchanging data with, one of the receiver/subscriber systems.

Additionally, the systems can include server systems that act as streaming media servers which have been programmed to implement the DRM processes of the invention. Similarly, the proprietary hardware devices can include receiver/client devices that comprise a micro-controller system executing programs for carrying out the described DRM processes. Optionally, the system can include signal processing systems for performing the processing. These systems can include any of the digital signal processors (DSP) capable of implementing the processing functions described herein, such as the DSP-based on the TMS320 core including those sold and manufactured by the Texas Instruments Company of Austin, Tex.

The systems and methods described above can also be embodied in system development kits (SDK) and tools for allowing some to build systems for distributing premium content, such as custom multimedia caller alerts. These systems can include a framework of a prefabricated structure, or template, of a working program. For example, for a traditional application program, a framework can provide support and “default” behavior for creating the custom table, managing a key table and for more mundane tasks like drawing windows, scroll bars and menus. Optionally, a framework can provide sufficient functionality and wired-in interconnections between object classes to provide an infrastructure for a developer developing services. The interconnections are generally understood to provide the architectural model and design for developers, allowing developers to focus on the problem domain and allowing increased levels of hardware independence, as frameworks can provide to developers abstractions of common communication devices, reducing the need to include hardware-dependent code within a service application.

The design and development of object oriented frameworks are described, for example, in Booch, Grady, “Designing an Application Framework”, Dr. Dobb's Journal 19, No. 2 (February, 1994); Booch, Grady, “Object Oriented Analysis and Design With Applications”, Redwood City, Calif. Benjamin/Cummings (1994); and Taligent, “Building Object Oriented Frameworks”, Taligent, Inc. (1994).

In one or more embodiments, the invention may employ, at least in part, systems and methods described by one or more of the following patents and patent applications, the entire content of each of which is incorporated herein by reference: Secure digital chaotic communication (U.S. Pat. No. 6,363,153); Method and apparatus for compressed chaotic music synthesis (U.S. Pat. No. 6,137,045); Method and apparatus for the compression and decompression of audio files using a chaotic system (U.S. patent application Ser. No. 09/597,101, filed on 20 Jun. 2000); Method and apparatus for the compression and decompression of image files using a chaotic system (U.S. patent application Ser. No. 09/756,814, filed on 09 Jan. 2001); Method and apparatus for remote digital key generation (U.S. Published Patent Application No. 20020164032, filed on 18 Mar. 2002, Ser. No. 10/099,812); and Method and apparatus for chaotic opportunistic lossless compression of data (U.S. Published Application No. 20020154770, filed on 26 Mar. 2002, Ser. No. 10/106,696).

Many equivalents to the specific embodiments of the invention described herein and the specific methods and practices associated with the invention exist. Applicants contemplate and consider within the patentable subject matter of this application, all operable combinations of the illustrative features, elements, systems, devices and methods described herein for transferring, encrypting, decrypting, compressing, decompressing, storing, and sharing and managing the rights pertaining to audio, video, image, text, tactile, software, and other digital content. Accordingly, the invention is not to be limited to the embodiments, methods, and practices disclosed herein, but is to be understood from the following claims, which are to be interpreted as broadly as allowed under the law.

1. A method of providing digital content to a first client device, the method comprising:
a. transforming original digital content into a first transformed digital content representative of a first portion of, and distinct from, the original digital content;
b. creating a first table of characteristics associated with the first transformed digital content, the first table of characteristics being necessary for inverse transforming the first transformed digital content into the first portion of the original digital content; and
c. transmitting the first transformed digital content and a representation of the first table of characteristics to the first client device.

2. The method of claim 1, comprising encrypting the first table of characteristics using an identifier uniquely associated with the first client device, to generate the representation of the first table of characteristics.

3. The method of claim 1, wherein the transforming includes compressing the original digital content.

4. The method of claim 1, wherein the first transformed digital content is smaller than the original digital content by a factor of at least about 10.

5. The method of claim 1, wherein the first transformed digital content is smaller than the original digital content by a factor of at least about 100.

6. The method of claim 1, wherein the first transformed digital content is smaller than the original digital content by a factor of at least about 1,000.

7. The method of claim 1, wherein the first transformed digital content is smaller than the original digital content by a factor of at least about 10,000.

8. The method of claim 1, wherein the first transformed digital content is smaller than the original digital content by a factor of at least about 100,000.

9. The method of claim 1, comprising employing the first table of characteristics to further compress the first transformed digital content.

10. The method of claim 1, wherein the first table of characteristics is smaller than the first transformed digital content by a factor of at least about 100.

11. The method of claim 1, wherein the first table of characteristics is smaller than the first transformed digital content by a factor of at least about 1,000.

12. The method of claim 1, wherein the first table of characteristics is smaller than the first transformed digital content by a factor of at least about 10,000.

13. The method of claim 1, wherein the first table of characteristics is smaller than the first transformed digital content by a factor of at least about 100,000.

14. The method of claim 1, including using the unique identifier to generate a digital key for encrypting the first table of characteristics.

15. The method of claim 1, including using the unique identifier as a digital key for encrypting the first table of characteristics.

16. The method of claim 1, wherein the device unique identifier is selected from the group consisting of a telephone number, EIN, MIN, MSISDN, serial number, number associated with a SIM card of the first client device, a public/private key encryption process, a MAC address of a modem associated with a computer, a personal identifier uniquely associated with a user, a proprietary identifier, and a combination thereof.

17. The method of claim 1, wherein the unique identifier includes any number stored at the first client device.

18. The method of claim 1, comprising optimizing the first table of characteristics for the at least one of the original digital content and the first transformed digital content.

19. The method of claim 1, comprising employing the first table of characteristics to remove redundancy in the first transformed digital content.

20. The method of claim 1, comprising retrieving the unique identifier from a database of unique identifiers.

21. The method of claim 1, wherein the first table of characteristics includes a dynamically created custom coding table.

22. The method of claim 1, wherein the custom coding table includes a custom Huffman coding table.

23. The method of claim 1, wherein the custom coding table includes an arithmetic coding table.

24. The method of claim 1, wherein the transmitting is performed over a wireless communication link.

25. The method of claim 1, wherein the first client device includes a wireless telephone.

26. The method of claim 1, wherein the first client device includes a media player.

27. The method of claim 1, wherein the first client device is chosen from the group consisting of a server computer, a desktop computer, a laptop computer, a handheld computer, a storage media, and a combination thereof.

28. The method of claim 1, comprising employing a chaotic system to transform the original digital content.

29. The method of claim 1, wherein employing the chaotic system comprises:
a. causing the chaotic system to assume a periodic orbit;
b. generating a periodic waveform for the periodic orbit;
c. weighting the periodic waveform to approximate a portion of the original digital content; and
d. merging at least one initialization code and a representation of the weighting, to compress the original digital content.

30. The method of claim 1, including stabilizing the periodic orbit.

31. The method of claim 1, including:
a. identifying a trend in the original digital content; and
b. removing the trend from the original digital content.

32. The method of claim 1, wherein identifying the trend includes determining a mathematical model for the trend.

33. The method of claim 1, including merging a representation of the trend, the at least one initialization code, and the representation of the weighting, to compress the original digital content.

34. The method of claim 1, wherein the original digital content includes audio data.

35. The method of claim 1, wherein the original digital content includes image data.

36. The method of claim 1, wherein the original digital content includes audio and image data.

37. The method of claim 1, wherein the original digital content includes video data.

38. The method of claim 1, wherein the original digital content includes video and audio data.

39. The method of claim 1, wherein the original digital content includes tactile data.

40. The method of claim 1, comprising:
a. decrypting the first table of characteristics using the unique identifier at the first client device; and
b. inverse transforming the first transformed digital content using the decrypted first table of characteristics, to reconstruct the first portion of the original digital content.

41. The method of claim 1, comprising playing the first portion of the original digital content during reconstruction of the first portion of the original digital content at the first client device, but not persistently storing a subset of the reconstructed digital content at the first client device.

42. The method of claim 1, comprising transmitting the first transformed digital content and the representation of the first table of characteristics from the first client device to a second client device.

43. The method of claim 1, comprising aborting inverse transformation of the first transformed digital content, in response to detecting that the second client device is not associated with the unique identifier.

44. The method of claim 1, comprising aborting inverse transformation of the first transformed digital content, in response to detecting that the first table of characteristics is invalid for the second client device.

45. The method of claim 1 comprising generating invalid digital content at the second client device, in response to an attempt to inverse transform the first transformed digital content at the second client device.

46. The method of claim 1, comprising generating invalid digital content at the second client device, in response to detecting that the unique identifier is not associated with the second client device.

47. The method of claim 1, comprising generating invalid digital content at the second client device, in response to detecting that the first table of characteristics is invalid for the second client device.

48. The method of claim 1, comprising, in response to determining that the second client device is incapable of inverse transforming digital content from the first device to produce a valid version of the first portion of the original digital content:
a. sending a request for access to the original digital content from the second client device to a host server; and
b. in response to determining, by the host server, that the second client device is authorized to receive the original digital content, transmitting, by the host server, a corrected first table of characteristics to the second client device to enable the second client device to inverse transform the first transformed digital content into a valid version of the first portion of the original digital content.

49. The method of claim 1, comprising:
a. prompting a user at the second client device to request, from a host server, access to the first portion of the original digital content;
b. generating a billing event at the host server to charge the user of the second client device for access to the first portion of the original digital content; and
c. transmitting a corrected first table of characteristics to the second client device to enable the second client device to inverse transform the first transformed digital content into a valid version of the first portion of the original digital content.

50. The method of claim 1, wherein the original digital content includes an associated preview version.

51. The method of claim 1, wherein the preview version has an inferior quality relative to the original digital content.

52. The method of claim 1, wherein the preview version has a shorter duration than the original digital content.

53. The method of claim 1, comprising transmitting the first transformed digital content and the representation of the first table of characteristics from the first client device to a second client device to enable the second client device to inverse transform the first transformed digital content into the first portion of the original digital content.

54. The method of claim 1, comprising:
a. transforming the original digital content into a second transformed digital content representative of a second portion, distinct from the first portion, of the original digital content;
b. creating a second table of characteristics associated with the second transformed digital content, the second table of characteristics being necessary for inverse transforming the second transformed digital content into the second portion of the original digital content; and
c. transmitting the second transformed digital content and a representation of the second table of characteristics to the first client device.

55. The method of claim 1, comprising encrypting the second table of characteristics using a unique identifier to generate the representation of the second table of characteristics.

56. The method of claim 1, wherein transmitting the first transformed digital content includes streaming a subset of the first transformed digital content to the first client device, and causing a portion of the streamed subset of the first transformed digital content to not be persistently stored at the first client device.

57. The method of claim 1, wherein the second transformed digital content is associated with the portion of the streamed first transformed digital content not persistently stored at the first client device, the second transformed digital content being persistently stored at the first client device.

58. The method of claim 1, wherein the unique identifier is associated with the first client device.

59. The method of claim 1, wherein the first client device can decrypt the encrypted second table of characteristics, inverse transform the first and second transformed digital contents, and play a combination of the first portion and the second portion of the original digital content.

60. The method of claim 1, wherein the unique identifier is not associated with the first client device and the first client device can only inverse transform the first transformed digital content and play only the first portion of the original digital content.

61. The method of claim 1, wherein the first portion of the original digital content is associated with a freely-distributable portion of the original digital content, intended for playing by any suitable client device, and the second portion of the original digital content is associated with a secure portion of the original digital content requiring decryption of the second table of characteristics.

62. The method of claim 1, wherein the first portion of the original digital content includes an advertisement or a promotion.

63. The method of claim 1, wherein the first portion of the original digital content includes a preview of the original digital content.

64. The method of claim 1, wherein the encrypting employs a chaotic system.

65. The method of claim 1, comprising regulating usage rights granted to the first client device.

66. The method of claim 1, wherein the regulating comprises limiting a number times the first client device may use the original digital content.

67. The method of claim 1, wherein the regulating comprises allowing the first client device to use the original digital content for a restricted length of time.

68. The method of claim 1, wherein the regulating comprises restricting a quality of the original digital content usable by the first client device.

69. The method of claim 1, including partitioning the original digital content into a plurality of layers associated with a respective plurality of quality of service levels.

70. The method of claim 1, wherein the first transformed digital content includes a subset of the layers associated with a desired quality of service level.

71. The method of claim 1, comprising varying the quality of service level based, at least in part, on availability of transmission bandwidth.

72. The method of claim 68, comprising:
a. decrypting the first table of characteristics at the first client device, using the identifier uniquely associated with the first client device; and
b. inverse transforming the first transformed digital content, using the decrypted first table of characteristics, to reconstruct the original digital content.

73. The method of claim 1, comprising altering noise-like data from the original digital content.

74. The method of claim 1, comprising, in response to determining that the first client device is authorized to use the original digital content, incorporating suitable data into the original digital content at the first client device to enable substantially accurate reconstruction of the original digital content at the first client device.

75. The method of claim 1, wherein the suitable data is produced, at least in part, by a first noise generator at the first client device.

76. The method of claim 1, wherein the suitable data is selected from the group consisting of random noise, pseudo-random noise, and a combination thereof.

77. The method of claim 1, wherein data produced by the first noise generator is uniquely associated with the first client device.

78. The method of claim 1, comprising initializing the first noise generator to an initial state.

79. The method of claim 1, wherein the initial state is uniquely associated with the first client device.

80. The method of claim 1, wherein data produced by the first noise generator is uniquely associated with the initial state.

81. The method of claim 1, comprising:
a. altering noise-like data from the original digital content; and
b. in response to determining that the first client device is not entitled to the original digital content, incorporating unsuitable data into the original digital content at the first client device to degrade reconstruction of the original digital content at the first client device.

82. A method of providing digital content to a first client device, the method comprising:
a. transforming original digital content into a first transformed digital content representative of, and distinct from, the original digital content;
b. creating a first table of characteristics associated with the first transformed digital content, the first table of characteristics being necessary for inverse transforming the first transformed digital content into the original digital content;
c. encrypting the first table of characteristics using a first chaotic system; and
d. transmitting the first transformed digital content and the encrypted first table of characteristics to the first client device.

83. The method of claim 1, wherein the encrypting includes:
a. causing the first chaotic system to assume a first phase space trajectory corresponding to a digital representation of the first table of characteristics, by applying at least one control to the first chaotic system; and
b. producing transmission data to be transmitted to the first client device, the transmission data including a digital representation of at least one initialization code and a digital representation of the at least one control, whereby a dynamic behavior of the first chaotic system cannot be reconstructed from the transmission data.

84. The method of claim 1, wherein the encrypting includes:
a. causing the first chaotic system to generate a first digital encryption key by applying an initialization code to the first chaotic system;
b. using the first digital encryption key in the encrypting of the first table of characteristics; and
c. producing transmission data to be transmitted to the first client device, the transmission data including the initialization code and the encrypted first table of characteristics, whereby a dynamic behavior of the first chaotic system cannot be reconstructed from the transmission data.
